(19) United States
(12) Patent Application Publication
(10) Pub. No.: US 2016/0154756 A1
(43) Pub. Date: Jun. 2, 2016

(54) UNORDERED MULTI-PATH ROUTING IN A PCIE EXPRESS FABRIC ENVIRONMENT

(71) Applicant: Avago Technologies General IP (Singapore) Pte. Ltd, Singapore (SG)

(72) Inventors: Jeffrey Michael DODSON, Portland, OR (US); Jack REGULA, Chapel Hill, NC (US); Natwar AGRAWAL, Mountain View, CA (US)

(21) Appl. No.: 14/558,404

(22) Filed: Dec. 2, 2014

(51) Int. Cl. G06F 13/40; G06F 13/42

(52) U.S. Cl. CPC G06F 13/4022; G06F 13/4282

(57) ABSTRACT

A method of providing unordered packet routing in a multi-path PCIe switch fabric is provided. Fabric egress port congestion is measured and distributed to all ports within a switch and to neighboring switches. An unordered route choice vector is generated by table lookup. The local congestion mask vector identifies which of these choices has local congestion. A next hop masked choice vector generated by table lookup is gated with the next hop congestion mask vectors, received from neighboring switches, to identify the choices that have next hop congestion. Congested choices are excluded by masking. If multiple choices remain at the conclusion of the masking process, then a selection is made by round-robin among the surviving choices. If no choices remain, the selection is made by round robin among the original choices. The final selection is mapped to an egress port on the switch by table lookup.

### CROSS REFERENCE TO RELATED APPLICATIONS

This application incorporates by reference, in their entirety and for all purposes herein, the following U.S. patents and pending applications: Ser. No. 14/231,079, filed Mar. 31, 2014, entitled, “MULTI-PATH ID ROUTING IN A PCIE EXPRESS FABRIC ENVIRONMENT.”

### FIELD OF THE INVENTION

The present invention is generally related to routing packets in a switch fabric, such as PLX Technology's “Express Fabric”.

### BACKGROUND OF THE INVENTION

Peripheral Component Interconnect Express (commonly described as PCI Express or PCIe) provides a compelling foundation for a high performance, low latency converged fabric. It has near-universal connectivity with silicon building blocks, and offers a system cost and power envelope that other fabric choices cannot achieve. PCIe has been extended by PLX Technology, Inc. to serve as a scalable converged rack level “ExpressFabric.”

However, the PCIe standard provides no means to handle routing over multiple paths, or for handling congestion while doing so. That is, conventional PCIe supports only tree structured fabric. There are no known solutions in the prior art that extend PCIe to multiple paths. Additionally, in a PCIe environment, there is also a need for shared input/output (I/O) and host-to-host messaging which should be supported.

### SUMMARY OF THE INVENTION

In a manifestation of the invention, a method of providing unordered path routing in a multi-path PCIe switch fabric is provided. A set of route choices for unordered traffic from the local (current) switch towards the final destination is provided via a current hop destination indexed look up table (CH D-LUT). A set of route choices from each of those possible current hop unordered route choices applicable at the next hop are stored in a next hop destination indexed look up table (NH-DLUT). The Port congestion on a local level is measured and communicated internally in the local switch via a congestion feedback interconnect. Congestion indication for the local switch comprises low priority congestion information and medium priority congestion information. A congestion feedback interconnect, in this manifestation a ring structure (other interconnect structures such as a bus could also be used), is used to communicate congestion feedback information within a chip, wherein only fabric ports send congestion information of the local level and an applicable next hop level to the congestion feedback ring. The congestion state is saved in local congestion vectors in every module in which routing are performed.

The Unordered Route Choice Mask Vectors, which represent the fault free route choices for unordered traffic that lead to the destination corresponding to the table index, are stored in a destination look up table CH DLUT. From the combination of the fault free route choices of paths to a destination, the local congestion information for the destination, the priority level of the packet and round-robin state information , an uncongested path will be selected to route the unordered packet. The congestion information is used to mask out route choices for which congestion is indicated. If a single choice survives this masking process, that choice is selected. If multiple route choices remain after this masking process or if congestion is indicated for all route choices, then the final route choice selection is made by a round robin process. In the former case, round robin is among the surviving choices. In the latter case, the round robin is among the original set of choices.

In another manifestation of the invention a method of providing unordered path routing in a multi-path PCIe switch fabric is provided. A set of route choices for unordered traffic from the local (current) switch towards the final destination is provided via a current hop destination indexed look up table (CH DLUT). Port congestion on a local level is measured and communicated to the local switch via a congestion feedback interconnect and the congestion state is saved in local congestion mask vectors in every port. At fabric ports, the local congestion state is communicated to the neighboring switches via data link layer packets (DLLPs) and then communicated within that neighboring switch via a congestion feedback interconnect. At each module in which routing is performed, the next hop congestion state is saved in a set of next hop congestion vectors with one such vector for each current hop unordered route choice. Congestion indication for both the local and the next hop switch comprises low priority congestion information and medium priority congestion information. A congestion feedback interconnect, in this manifestation a ring structure (other interconnect structures such as a bus could also be used), is used to communicate congestion feedback information within a chip, wherein only fabric ports send congestion information of the local level and an applicable next hop level to the congestion feedback ring. For each current hop unordered route choice, there is a set of next hop choices that lead to the destination if the associated current hop route choice is taken. These next hop masked choice vectors are saved in a next hop destination look up table (NH-DLUT). The next hop masked choice vectors are used in conjunction with Port_for_Choice tables to construct next hop masked port vectors. These vectors are in turn used to select the next hop congestion information that is associated with the destination of the packet being routed. From the combination of the choices of paths to a destination, the local congestion information for the destination, the next hop congestion information for the destination, and the priority level of the packet, and round-robin state information, an uncongested path is selected to route the unordered packet. The congestion information is used to mask out route choices for which congestion is indicated. If a single choice survives this masking process, that choice is selected. If multiple route choices remain after this masking process or if congestion is indicated for all route choices, then the final route choice selection is made by a round robin process. In the former case, round robin is among the surviving choices. In the latter case, the round robin is among the original set of choices. In one manifestation of the invention, this tie breaking is done by a simple round robin selection mechanism that is independent of the packet's destination. In another manifestation of the invention, separate round robin information is maintained and used in this process for each destination edge switch.

In another manifestation of the invention, a system is provided. A switch fabric is provided including at least three PLX ExpressFabric switches and a management system, wherein each switch comprises a plurality of ports, wherein some of the ports are fabric ports that are connected to other switches, and each switch includes a congestion feedback interconnect which collects congestion information only from fabric ports, wherein the congestion information provides port congestion on a local level and port congestion on an applicable next hop level. Congestion is indicated for a port when the depth of all of its egress queues in total exceeds a configurable threshold. An egress scheduler and router is provided that applies the destination independent local congestion mask vector and the destination specific next hop congestion port vector created using the NH-DLUT and the Port_for_Choice tables to the congestion vectors to produce a vector that indicates route choices for which congestion is indicated. It applies this vector to the destination specific masked choice vector from the CH-DLUT to exclude route choices for which congestion is indicated. If multiple route choices remain after this masking process or if congestion is indicated for all route choices, then the final route choice selection is made by a round robin process, where the round-robin may be either destination agnostic or round robin per destination edge switch. In the final route step, the surviving route choice is mapped to a fabric egress port via a choice to port look up table.

These and other features of the present invention will be described in more detail below in the detailed description of the invention and in conjunction with the following figures.

### BRIEF DESCRIPTION OF THE DRAWINGS

FIGS. 1 is a block diagram of switch fabric system in accordance with an embodiment of the present invention.

FIG. 2 illustrates simulated throughput versus total message payload size in a Network Interface Card (NIC) mode for an embodiment of the present invention.

FIG. 3 illustrates the MCPU (Management Central Processing Unit) view of the switch's PCIe Configuration Space in accordance with an embodiment of the present invention.

FIG. 4 illustrates a host port's view of the PCIe Configuration Space that it sees when enumerating an embodiment of the present invention.

FIG. 5 illustrates an exemplary ExpressFabricTM Routing prefix in accordance with an embodiment of the present invention.

FIG. 6 illustrates the use of a ternary CAM (T-CAM) to implement address traps.

FIG. 7 illustrates an implementation of ID trap definition.

FIG. 8 illustrates CH-DLUT route lookup table in accordance with an embodiment of the present invention.

FIG. 9 illustrates vendor specific DLLP formats used in an embodiment of the present invention.

FIG. 10 illustrates a 3-stage Clos Network.

FIG. 11 illustrates current and next hop routes in a Clos Network.

FIG. 12 shows the format in which congestion information is stored in each station of the switch.

FIG. 13 is a simplified illustration of the logic for selecting a particular egress port for an unordered TLP:

FIG. 14 is a congestion feedback ring block diagram, which shows a ring interconnect for communication congestion information within a switch.

FIG. 15 is a block diagram of the Congestion Information Management block, and illustrates logic used to detect congestion and maintain congestion state.

FIG. 16 illustrates a two stage lookup of a flow state.

FIG. 17 is a format of Vendor defined DLLP used for congestion feedback.

FIG. 18 is another format of Vendor defined DLLP used for congestion feedback.

### DETAILED DESCRIPTION

A switch fabric may be used to connect multiple hosts. A PCIe switch implements a fabric-wide Global ID, GID, that is used for routing between and among hosts and endpoints connected to edge ports of the fabric or embedded within it and means to convert between conventional PCIe address based routing used at the edge ports of the fabric and Global ID based routing used within it. GID based routing is the basis for additional functions not found in standard PCIe switches such as support for host to host communications using ID-routed messages, support for multi-host shared I/O, support for routing over multiple/redundant paths, and improved security and scalability of host to host communications compared to non-transparent bridging.

A commercial embodiment of the switch fabric described in U.S. patent application Ser. No. 13/660,791 (and the other patent applications and patents incorporated by reference) was developed by PLX Technology, Inc. and is known as ExpressFabric™. An exemplary switch architecture developed by PLX, Technology, Inc. to support ExpressFabric™ is the Capella 2 switch architecture, aspects of which are also described in the patent applications and patents incorporated by reference. The edges of the ExpressFabric are labeled nodes where a node may be a path to a server (a host port) or a path to an endpoint (a downstream port). ExpressFabric™ host-to-host messaging uses ID-routed PCIe Vendor Defined Messages together with routing mechanisms that allow non-blocking fat tree (and diverse other topology) fabrics to be created that contain multiple paths between host nodes.

One aspect of embodiments of the present invention is that unlike standard point-to-point PCIe, multi-path routing is supported in the switch fabric to handle ordered and unordered routing, as well as load balancing. Embodiments of the present invention include a route table that identifies multiple paths to each destination ID together with the means for choosing among the different paths that tend to balance the loads across them, preserve producer/consumer ordering, and/or steer the subset of traffic that is free of ordering constraints onto relatively uncongested paths.

Traffic sent between nodes using ExpressFabric can be generally categorized as either ordered traffic, where two subsequent packets must stay in relative order with respect to each other, and unordered traffic, where two subsequent packets can arrive in any order. In a complex system with multiple hosts and multiple endpoints, some paths may be congested. If the congested paths can be determined, unordered traffic can be routed to avoid the congestion and thereby increase overall fabric performance. Before congestion develops, unordered traffic can be load balanced across multiple paths to avoid congestion.

### 1.1 System Architecture Overview

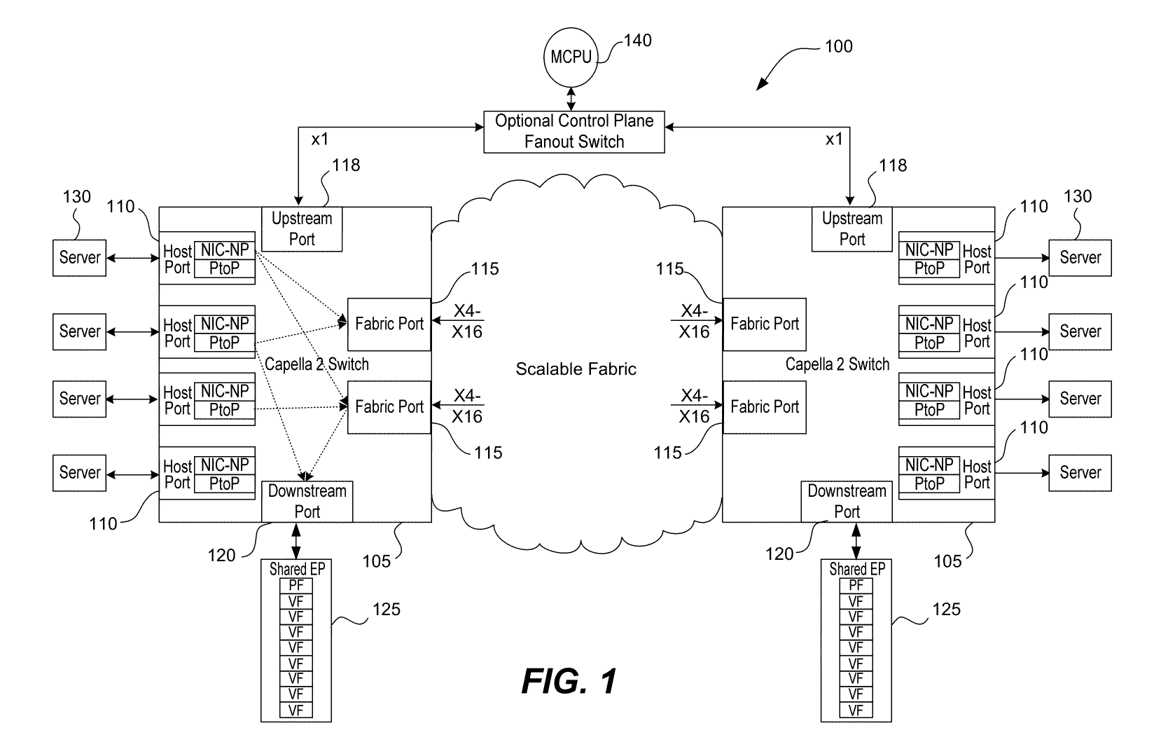

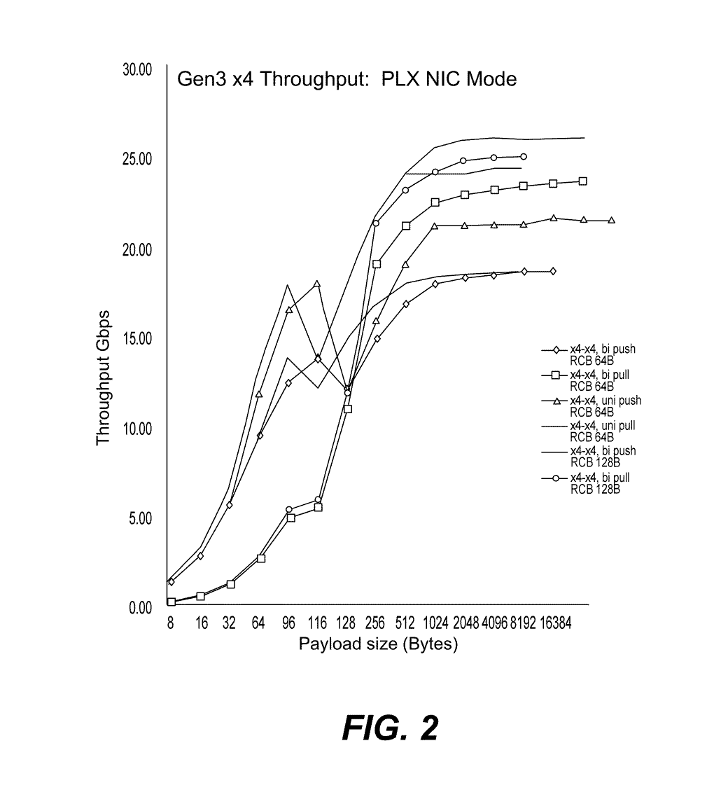

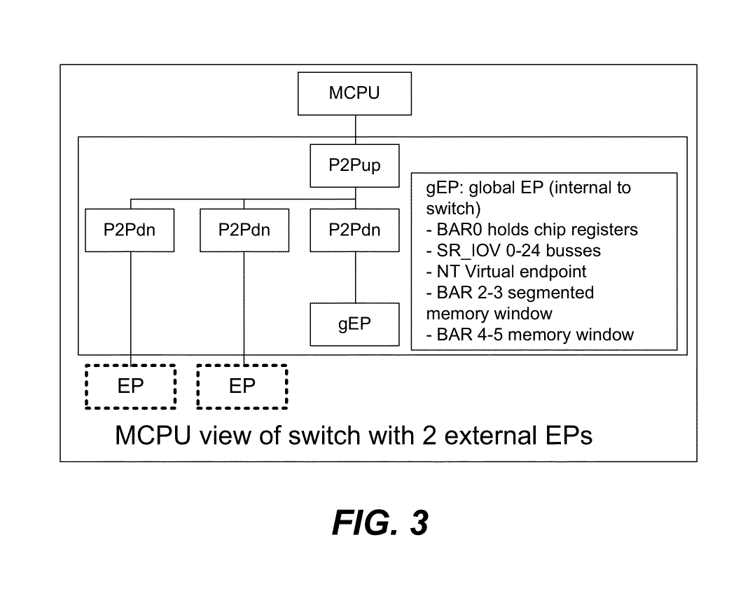

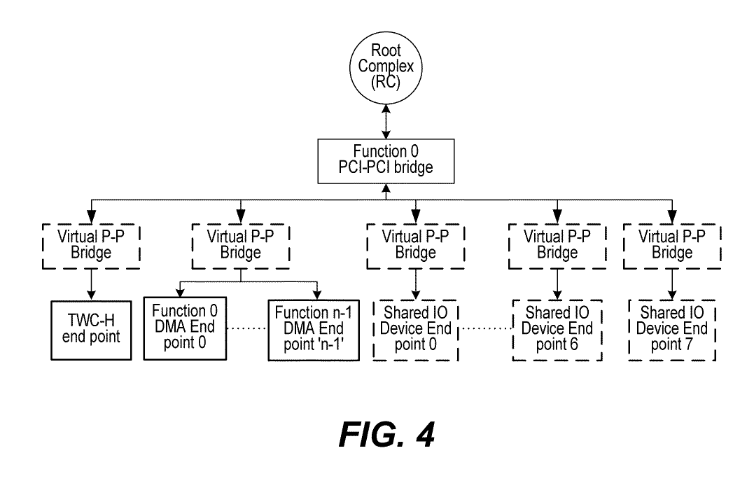

Embodiments of the present invention are now discussed in the context of switch fabric implementation. FIG. 1 is a diagram of a switch fabric system 100. Some of the main system concepts of ExpressFabric™ are illustrated in FIG. 1, with reference to a PLX switch architecture known as Capella 2.

Each switch 105 may include host ports 110, fabric ports 115, an upstream port 118, and downstream port(s) 120. The individual host ports 110 each lead eventually to a host root complex such as a server 130. In the ExpressFabric switch, a host port gives a host access to host to host functions such as a Network function for DMA and a Tunneled Window Connection for programmed IO. In this example, a shared endpoint 125 is coupled to the downstream port and includes physical functions (PFs) and Virtual Functions (VFs). Individual servers 130 may be coupled to individual host ports. The fabric is scalable in that additional switches can be coupled together via the fabric ports. While two switches are illustrated, it will be understood that an arbitrary number may be coupled together as part of the switch fabric, symbolized by the cloud in FIG. 1. While a Capella 2 switch is illustrated, it will be understood that embodiments of the present invention are not limited to the Capella 2 switch architecture.

A Management Central Processor Unit (MCPU) 140 is responsible for fabric and I/O management and must include an associated memory having management software (not shown). In one optional embodiment, a semiconductor chip implementation uses a separate control plane 150 and provides an x1 port for this use. Multiple options exist for fabric, control plane, and MCPU redundancy and fail over, including incorporating the MCPU into the switch silicon. The Capella 2 switch supports arbitrary fabric topologies with redundant paths and can implement fabrics that scale from two switch chips and two nodes to hundreds of switches and thousands of nodes.

In one embodiment, inter-processor communications are supported by RDMA-NIC emulating DMA controllers at every host port and by a Tunneled Window Connection (TWC) mechanism that implements a connection oriented model for ID-routed PIO access among hosts The RDMA-NIC can send ordered and unordered traffic across the fabric. The TWC can send only ordered traffic across the fabric.

A Global Space in the switch fabric is defined. The hosts communicate by exchanging ID routed Vendor Defined Messages in a Global Space after configuration by MCPU software.

In one embodiment, the fabric ports 115 are PCIe downstream switch ports enhanced with fabric routing, load balancing, and congestion avoidance mechanisms that allow full advantage to be taken of redundant paths through the fabric and thus allow high performance multi-stage fabrics to be created.

In one embodiment, a unique feature of fabric ports is that their control registers don't appear in PCIe Configuration Space. This renders them invisible to BIOS and OS boot mechanisms that understand neither redundant paths nor congestion issues and allows the management software to configure and manage the fabric.

### 1.2. Use of Vendor Defined Messaging and ID Routing

In one embodiment Capella 2's host-to-host messaging protocol includes transmission of a work request message to a destination DMA VF by a source DMA VF, the execution of the requested work by that DMA VF and then the return of a completion message to the source DMA VF with optional, moderated notification to the recipient as well. These messages appear on the wire as ID routed Vendor Defined Messages (VDMs). Message pull-protocol read requests that target the memory of a remote host are also sent as ID-routed VDMs. Since these are routed by ID rather than by address, the message and the read request created from it at the destination host can contain addresses in the destination's address domain. When a read request VDM reaches the target host port, it is changed to a standard read request and forwarded into the target host's space without address translation.

A primary benefit of ID routing is its easy extension to multiple PCIe bus number spaces by the addition of a Vendor Defined End-to-End Prefix containing source and destination bus number “Domain” ID fields as well as the destination BUS number in the destination Domain. Domain boundaries naturally align with packaging boundaries. Systems can be built wherein each rack, or each chassis within a rack, is a separate Domain with fully non-blocking connectivity between Domains.

Using ID routing for message engine transfers simplifies the address space, address mapping and address decoding logic, and enforcement of the producer/consumer ordering rules. The ExpressFabric™ Global ID is analogous to an Ethernet MAC address and, at least for purposes of tunneling Ethernet through the fabric, the fabric performs similarly to a Layer 2 Ethernet switch.

The ability to differentiate message engine traffic from other traffic allows use of relaxed ordering rules for message engine data transfers. This results in higher performance in scaled out fabrics. In particular, work request messages are considered strongly ordered while prefixed reads and their completions are unordered with respect to these or other writes. Host-to-host read requests and completion traffic can be spread over the redundant paths of a scaled out fabric to make best use of available redundant paths.

1.3 Push vs. Pull Messaging

In one embodiment, a Capella 2 switch pushes short messages that fit within the supported descriptor size of 128 B, or can be sent by a small number of such short messages sent in sequence, and pulls longer messages.

In push mode, these unsolicited messages are written asynchronously to their destinations, potentially creating congestion there when multiple sources target the same destination. Pull mode message engines avoid congestion by pushing only relatively short pull request messages that are completed by the destination DMA returning a read request for the message data to be transferred. Using pull mode, the sender of a message can avoid congestion due to multiple targets pulling messages from its memory simultaneously by limiting the number of outstanding message pull requests it allows. A target can avoid congestion at its local host's ingress port by limiting the number of outstanding pull protocol remote read requests. In a Capella 2 switch, both outstanding DMA work requests and DMA pull protocol remote read requests are managed algorithmically so as to avoid congestion.

Pull mode has the further advantage that the bulk of host-to-host traffic is in the form of read completions. Host-to-host completions are unordered with respect to other traffic and thus can be freely spread across the redundant paths of a multiple stage fabric.

### ExpressFabric Routine Concepts

### 2.1 Port Types and Attributes

Referring again to FIG. 1, in one embodiment of ExpressFabric™, switch ports are classified into four types, each with an attribute. The port type is configured by setting the desired port attribute via strap and/or serial EEPROM and thus established prior to enumeration Implicit in the port type is a set of features/mechanisms that together implement the special functionality of the port type.

In the preferred embodiment of the invention, the port types are:
1) A Management Port, which is a connection to the MCPU (upstream port 118 of FIG. 1);
2) A Downstream Port (port 120 of FIG. 1), which is a port where an end point device is attached;
3) A Fabric Port (port 115 of FIG. 1), which is a port that connects to another switch in the fabric, and which may implement ID routing and congestion management;
4) A Host Port (port 110 of FIG. 1), which is a port at which a host/server may be attached.

### 2.2 Global ID

Every PCIe function of every node (edge host or downstream port of the fabric) has a unique Global ID that is composed of {domain, bus, function}. The Global ID domain and bus numbers are used to index the routing tables. A packet whose destination is in the same domain as its source uses the bus to route. A packet whose destination is in a different domain uses the domain to route at some point or points along its path.

### 2.2.3 Global ID Map

### Host IDs

Each host port 110 consumes a Global BUS number. At each host port, DMA VFs use FUN 0 . . . NumVFs-1. X16 host ports get 64 DMA VFs ranging from 0 . . . 63. X8 host ports get 32 DMA VFs ranging from 0 . . . 31. X4 host ports get 16 DMA VFs ranging from 0 . . . 15.

The Global RID of traffic initiated by a requester in the RC connected to a host port is obtained via a TWC Local-Global RID-LUT. Each RID-LUT entry maps an arbitrary local domain RID to a Global FUN at the Global BUS of the host port. The mapping and number of RID LUT entries depends on the host port width as follows:
1) {HostGlobalBUS, 3′b111, EntryNum} for the 32-entry RID LUT of an x4 host port;
2) {HostGlobalBUS, 2′b11, EntryNum} for the 64 entry RID LUT of an x8 host port; and
3) {HostGlobalBUS, 1′b1, EntryNum} for the 128 entry RID LUT of an x16 host port.

The leading most significant 1's in the FUN indicate a non-DMA requester. One or more leading 0's in the fun at a host's Global BUS indicate that the FUN is a DMA VF.

### Endpoint IDs

Endpoints, shared or unshared, may be connected at fabric edge ports with the Downstream Port attribute. Their FUNs (e.g. PFs and VFs) use a Global BUS between SEC and SUB of the downstream port's virtual bridge. At 2013's SRIOV VF densities, endpoints typically require a single BUS. ExpressFabricTM architecture and routing mechanisms fully support future devices that require multiple Busses to be allocated at downstream ports.

For simplicity in translating IDs, fabric management software configures the system so that except when the host doesn't support ARI, the Local FUN of each endpoint VF is identical to its Global FUN. In translating between any Local Space and Global Space, it's only necessary to translate the BUS number. Both Local to Global and Global to Local Bus Number Translation tables are provisioned at each host port and managed by the MCPU.

If ARI isn't supported, then Local FUN[2:0]==Global FUN[2:0] and Local Fun[7:3]==5′b000 00.

2.3 Navigating through Global Space

In one embodiment, ExpressFabric™ uses standard PCIe routing mechanisms augmented to support redundant paths through a multiple stage fabric.

In one embodiment, ID routing is used almost exclusively within Global Space by hosts and endpoints, while address routing is sometimes used in packets initiated by or targeting the MCPU. At fabric edges, CAM data structures provide a Destination BUS appropriate to either the destination address or Requester ID in the packet. The Destination BUS, along with Source and Destination Domains, is put in a Routing Prefix prepended to the packet, which, using the now attached prefix, is then ID routed through the fabric. At the destination fabric edge switch port, the prefix is removed exposing a standard PCIe TLP containing, in the case of a memory request, an address in the address space of the destination. This can be viewed as ID routed tunneling.

Routing a packet that contains a destination ID either natively or in a prefix starts with an attempt to decode an egress port using the standard PCIe ID routing mechanism. If there is only a single path through the fabric to the Destination BUS, this attempt will succeed and the TLP will be forwarded out the port within whose SEC-SUB range the Destination BUS of the ID hits. If there are multiple paths to the Destination BUS, then fabric configuration will be such that the attempted standard route fails. For ordered packets, the current hop destination lookup table (CH-DLUT) Route Lookup mechanism described below will then select a single route choice. For unordered packets, the CH-DLUT route lookup will return a number of alternate route choices. Fault and congestion avoidance logic will then select one of the alternatives. Choices are masked out if they lead to a fault, or to a congestion hot spot, or to prevent a loop from being formed in certain fabric topologies. In one implementation, a set of mask filters is used to perform the masking. Selection among the remaining, unmasked choices is via a “round robin” algorithm.

The CH-DLUT route lookup is used when the PCIe standard active port decode (as opposed to subtractive route) doesn't hit. The active route (SEC-SUB decode) for fabric crosslinks, is topology specific. For example, for all ports leading towards the root of a fat tree fabric, the SEC/SUB ranges of the fabric ports are null, forcing all traffic to the root of the fabric to use the DLUT Route Lookup. Each fabric crosslink of a mesh topology would decode a specific BUS number or Domain number range. With some exceptions, TLPs are ID-routed through Global Space using a PCIe Vendor Defined End-to-End Prefix. Completions and some messages (e.g. ID routed Vendor Defined Messages) are natively ID routed and require the addition of this prefix only when source and destination are in different Domains. Since the MCPU is at the upstream port of Global Space, TLPs may route to it using the default (subtractive) upstream route of PCIe, without use of a prefix. In the current embodiment, there are no means to add a routing prefix to TLPs at the ingress from the MCPU, requiring the use of address routing for its memory space requests. PCIe standard address and ID route mechanisms are maintained throughout the fabric to support the MCPU.

With some exceptions, PCIe message TLPs ingress at host and downstream ports are encapsulated and redirected to the MCPU in the same way as are Configuration Space requests. Some ID routed messages are routed directly by translation of their local space destination ID to the equivalent Global Space destination ID.

### 2.3.1. Routing Prefix

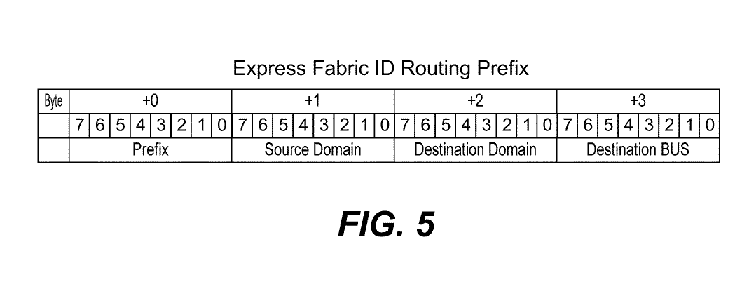

Support is provided to extend the ID space to multiple Domains. In one embodiment, an ID routing prefix is used to convert an address routed packet to an ID routed packet. An exemplary ExpressFabric™ Routing prefix is illustrated in FIG. 5.

A Vendor (PLX) Defined End-to-End Routing Prefix is added to memory space requests at the edges of the fabric. The method used depends on the type of port at which the packet enters the fabric and its destination:

At host ports:
a. For host to host transfers via TWC, the TLUT in the TWC is used to lookup the appropriate destination ID based on the address in the packet (details in TWC patent app incorporated by reference)
b. For host to I/O transfers, address traps are used to look up the appropriate destination ID based on the address in the packet, details in a subsequent subsection.

At downstream ports:
a. For I/O device to I/O device (peer to peer) memory space requests, address traps are used to look up the appropriate destination ID based on the address in the packet, details in a subsequent subsection. If this peer to peer route look up hits, then the ID trap lookup isn't done.
b. For I/O device to host memory space requests, ID Traps are used to look up the appropriate destination ID based on the Requester ID in the packet, details in a subsequent subsection.

The Address trap and TWC-H TLUT are data structures used to look up a destination ID based on the address in the packet being routed. ID traps associate the Requester ID in the packet with a destination ID:
1) In the ingress of a host port, by address trap for MMIO transfers to endpoints initiated by a host, and by TWC-H TLUT for host to host PIO transfers; and
2) In the ingress of a downstream port, by address trap for endpoint to endpoint transfers, by ID trap for endpoint to host transfers. If a memory request TLP doesn't hit a trap at the ingress of a downstream port, then no prefix is added and it address routes, ostensibly to the MCPU.

In one embodiment, the Routing Prefix is a single DW placed in front of a TLP header. Its first byte identifies the DW as an end-to-end vendor defined prefix rather than the first DW of a standard PCIe TLP header. The second byte is the Source Domain. The third byte is the Destination Domain. The fourth byte is the Destination BUS. Packets that contain a Routing Prefix are routed exclusively by the contents of the prefix.

Legal values for the first byte of the prefix are 9Eh or 9Fh, and are configured via a memory mapped configuration register.

### Prioritized Trap Routing

Routing traps are exceptions to standard PCIe routing. In forwarding a packet, the routing logic processes these traps in the order listed below, with the highest priority trap checked first. If a trap hits, then the packet is forwarded as defined by the trap. If a trap doesn't hit, then the next lower priority trap is checked. If none of the traps hit, then standard PCIe routing is used.

### Multicast Trap

The multicast trap is the highest priority trap and is used to support address based multicast as defined in the PCIe specification. This specification defines a Multicast BAR which serves as the multicast trap. If the address in an address routed packet hits in an enabled Multicast BAR, then the packet is forwarded as defined in the PCIe specification for a multicast hit.

### 2.3.2 Address Trap

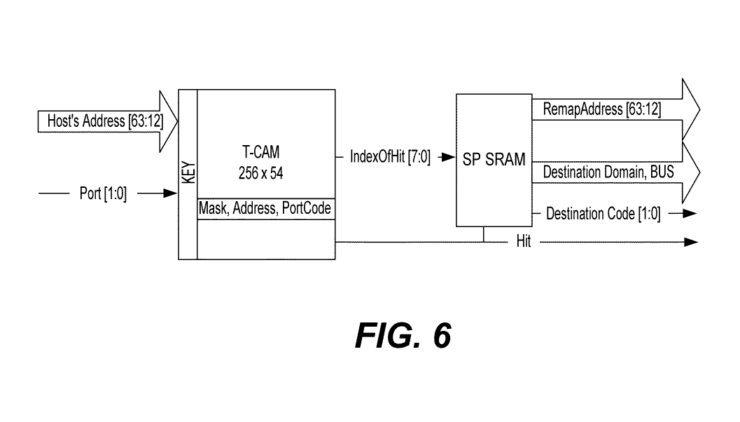

FIG. 6 illustrates the use of a ternary CAM (T-CAM) to implement address traps. Address traps appear in the ingress of host and downstream ports. In one embodiment they can be configured in-band only by the MCPU and out of band via serial EEPROM or I2C. Address traps are used for the following purposes:
1) Providing a downstream route from a host to an I/O endpoint using one trap per VF (or contiguous block of VFs) BAR;
2) Decoding a memory space access to host port DMA registers using one trap per host port;
3) Decoding a memory aperture in which TLPs are redirected to the MCPU to support BarO access to a synthetic endpoint; and
4) Supporting peer-to-peer access in Global Space.

Each address trap is an entry in a ternary CAM, as illustrated in FIG. 6. The T-CAM is used to implement address traps. Both the host address and a 2-bit port code are associated into the CAM. If the station has 4 host ports, then the port code identifies the port. If the station has only 2 host ports then the MSB of the port code is masked off in each CAM entry. If the station has a single host port, then both bits of the port code are masked off.

The following outputs are available from each address trap:
1) RemapOffset[63:12]. This address is added to the original address to affect an address translation. Translation by addition solves problem when one side of NT address is on a lower alignment than the size of the translation and in those cases, translation by replacement under mask will fail, e.g. a 4M aligned address with a size of 8M;
2) Destination{Domain,Bus}[15:0]. The Domain and BUS are inserted into a Routing Prefix that is used to ID route the packet when required per the CAM Code.

A CAM Code determines how/where the packet is forwarded, as follows:
a) 000=add ID routing prefix and ID route normally
b) 001=add ID routing prefix and ID route normally to peer
c) 010=encapsulate the packet and redirect to the MCPU
d) 011=send packet to the internal chip control register access mechanism
e) 1×0=send to the local DMAC assigning VFs in increasing order
f) 1×1=send to the local DMAC assigning VFs in decreasing order

If sending to the DMAC, then the 8 bit Destination BUS and Domain fields are repurposed as:
a) DestBUS field is repurposed as the starting function number of station DMA engine and
b) DestDomain field is repurposed as Number of DMA functions in the block of functions mapped by the trap.
c) Address Trap Registers

Hardware uses this information along with the CAM code (forward or reverse mapping of functions) to arrive at the targeted DMA function register for routing, while minimizing the number of address traps needed to support multiple DMA functions.

The T-CAM used to implement the address traps appears as several arrays in the per-station global endpoint BARO memory mapped register space. The arrays are:
a) CAM Base Address lower
b) CAM Base Address upper
c) CAM Address Mask lower
d) CAM Address Mask upper
e) CAM Output Address lower
f) CAM Output Address upper
g) CAM Output Address Ctrl
h) CAM Output Address Rsvd

An exemplary array implementation is illustrated in the table below.

| | Default | | | | | |
|---|---|---|---|---|---|---|
| | Value | Attribute | EEPROM | Reset | | |
| Offset | (hex) | (MCPU) | Writable | Level | Register or Field Name | Description |
| | | | | | Address Mapping CAM | Address Trap |
| Array | 256 | 1 | | | | |
| E000h | | | | | CAM Base Address lower | |
| [2:0] | | RW | Yes | Level01 | CAM port | |
| [11:3] | | RsvdP | No | Level0 | | |
| [31:12] | | RW | Yes | Level01 | CAM Base Address 31-12 | |
| E004h | | | | | CAM Base Address upper | |
| [31:0] | | RW | Yes | Level01 | CAM Base Address 63-32 | |
| E008h | | | | | CAM Address Mask lower | |
| [2:0] | | RW | Yes | Level01 | CAM Port Mask | |
| [3] | | RW | Yes | Level01 | CAM Vld | |
| [11:3] | | RsvdP | No | Level0 | | |
| [31:12] | | RW | Yes | Level01 | CAM Address Mask 31-12 | |
| E00Ch | | | | | CAM Address Mask upper | |
| [31:0] | | RW | Yes | Level01 | CAM Port Mask 63-32 | |
| End | | | | | | EFFCh |
| Array | 256 | 1 | | | | |
| F000h | | | | | CAM Output Address lower | Mapped address part of the |
| | | | | | | cam lookup value |
| [5:0] | | RW | Yes | Level01 | CAM Address Size | |
| [11:6] | | RsvdP | No | Level0 | | |
| [31:12] | | RW | Yes | Level01 | CAM Output Xlat Address 31- | remap offset 31-12. value to |
| | | | | | 12 | add to tlp address to get the |
| | | | | | | cam xlated address |
| F004h | | | | | CAM Output Address upper | Mapped address part of the |
| | | | | | | cam lookup value |
| [31:0] | | RW | Yes | Level01 | CAM Output Xlat Address 63- | remap offset 63-32 |
| | | | | | 32 | |
| F008h | | | | | CAM Output Address Ctrl | Mapped address part of the |
| | | | | | | cam lookup value |
| [7:0] | | RW | Yes | Level01 | Destination Bus | |
| [15:8] | | RW | Yes | Level01 | Destination Domain | |
| [18:16] | | RW | Yes | Level01 | CAM code | 0 = normal entry, 1 = peer to |
| | | | | | | peer, 2 = encap, 3 = chime, 4- |
| | | | | | | 7 = special entries with |
| | | | | | | bit0 = incremental direction, |
| | | | | | | bit1 = dma barentry |
| [24:19] | | RW | Yes | Level01 | vf start index | |
| [30:25] | | RW | Yes | Level01 | vf count | number of vf associated with |
| | | | | | | this entry −1. valid values |
| | | | | | | are 0/1/3/7/15/31/63 |
| [31] | | RW | Yes | Level01 | unused | |
| F00Ch | | | | | CAM Output Address Rsvd | Mapped address part of the |
| | | | | | | cam lookup value |
| [31:0] | | RsvdP | No | Level0 | | |
| End | | | | | | FFFCh |

### 2.3.3 ID Trap

ID traps are used to provide upstream routes from endpoints to the hosts with which they are associated. ID traps are processed in parallel with address traps at downstream ports. If both hit, the address trap takes priority.

Each ID trap functions as a CAM entry. The Requester ID of a host-bound packet is associated into the ID trap data structure and the Global Space BUS of the host to which the endpoint (VF) is assigned is returned. This BUS is used as the Destination BUS in a Routing Prefix added to the packet. For support of cross Domain I/O sharing, the ID Trap is augmented to return both a Destination BUS and a Destination Domain for use in the ID routing prefix.

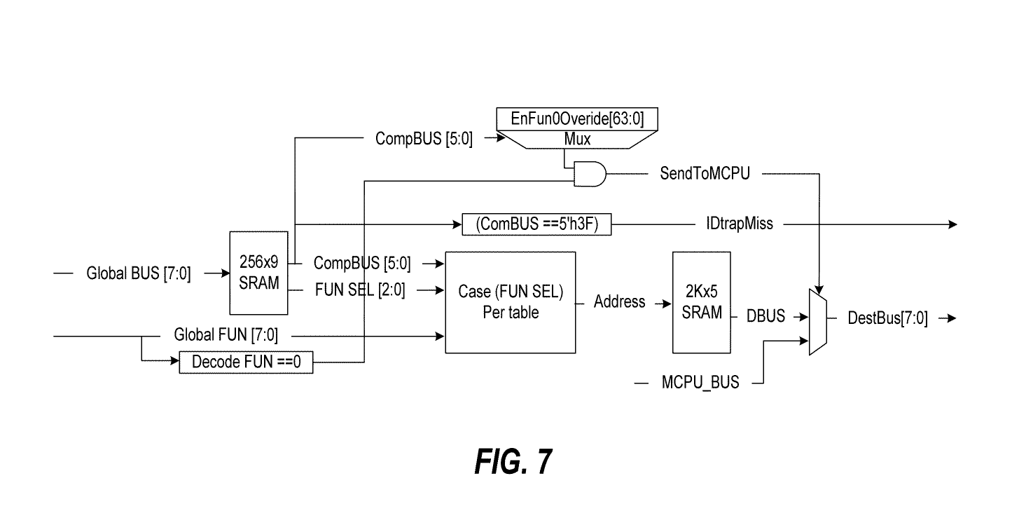

In an embodiment, ID traps are implemented as a two-stage table lookup. Table size is such that all FUNs on at least 31 global busses can be mapped to host ports. FIG. 7 illustrates an implementation of ID trap definition. The first stage lookup compresses the 8 bit Global BUS number from the Requester ID of the TLP being routed to a 7-bit CompBus and a FUN_SEL code that is used in the formation of the second stage lookup, per the case statement of Table 1 Address Generation for 2nd Stage ID Trap Lookup. The FUN_SEL options allow multiple functions to be mapped in contiguous, power of two sized blocks to conserver mapping resources. Additional details are provided in the shared I/O subsection.

The table below illustrates address generation for 2nd stage ID trap lookup.

| FUN SEL | Address Output | Application |
|---|---|---|
| 3′b000 | {CompBus[2:0], GFUN[7:0]} | Maps 256 FUNs on each of 8 |
| | | busses |
| 3′b001 | {CompBus[3:0], GFUN[6:0]} | Maps 128 FUNs on each of |
| | | 16 busses |
| 3′b010 | {CompBus[4:0], GFUN[5:0]} | Maps 64 FUNs on each of 32 |
| | | busses |
| 3′b011 | {CompBus[3:0], GFUN[7:1]} | Maps blocks of 2 VFs on 16 |
| | | busses |
| 3′b100 | {CompBus[4:0], GFUN[7:2]} | Maps blocks of 4 VFs on 32 |
| | | busses |
| 3′b101 | {CompBus[5:0], GFUN[7:3]} | Maps blocks of 8 VFs on 64 |
| | | busses |
| 3′b110 | Reserved | |
| 3′b111 | Reserved | |

### ID Traps in Register Space

The ID traps are implemented in the Upstream Route Table that appears in the register space of the switch as the three arrays in the per station GEP BARO memory mapped register space. The three arrays shown in the table below correspond to the two stage lookup process with FUNO override described above.

The table below illustrates an Upstream Route Table Containing ID Traps.

| | Default | | | | | |
|---|---|---|---|---|---|---|
| | Value | Attribute | EEPROM | Reset | | |
| Offset | (hex) | (MCPU) | Writable | Level | Register or Field Name | Description |
| | | | | | Bus Number | ID Trap |
| | | | | | Compression RAM | |
| Array | 128 | | | | | |
| BC00h | | | | | USP_block_idx_even | |
| [5:0] | | RW | Yes | Level01 | Block Number for Bus | |
| [7:6] | | RsvdP | No | Level0 | | |
| [10:8] | | RW | Yes | Level01 | Function Select for Bus | |
| [11] | | RW | Yes | Level01 | SRIOV global bus flag | |
| [15:12] | | RsvdP | No | Level0 | | |
| BC02h | | | | | USP_block_idx_odd | |
| [5:0] | | RW | Yes | Level01 | Block Number for Bus | |
| [7:6] | | RsvdP | No | Level0 | | |
| [10:8] | | RW | Yes | Level01 | Function Select for Bus | |
| [11] | | RW | Yes | Level01 | SRIOV global bus flag | |
| [15:12] | | RsvdP | No | Level0 | | |
| End | | | | | | BDFCh |
| BE00h | | | | | Fun0Override_Blk0_31 | |
| [31:0] | | RW | Yes | Level01 | | |
| BE04h | | | | | Fun0Override_Blk32_63 | |
| [31:0] | | RW | Yes | Level01 | | |
| | | | | | Second Level Upstream | ID Trap |
| | | | | | Routing Table | |
| Array | 1024 | 1 | | | | |
| C000h | | | | | Entry_port_even | The even and odd |
| | | | | | | dwords must be |
| | | | | | | written sequentially |
| | | | | | | for hardware to |
| | | | | | | update the memory |
| [7:0] | | RW | Yes | Level01 | Entry_destination_bus | |
| [15:8] | | RW | Yes | Level01 | Entry_destination_domain | |
| [16] | | RW | Yes | Level01 | Entry_vld | |
| [31:17] | | RsvdP | No | Level0 | | |
| C004h | | | | | Entry_port_odd | |
| [7:0] | | RW | Yes | Level01 | Entry_destination_bus | |
| [15:8] | | RW | Yes | Level01 | Entry_destination_domain | |
| [16] | | RW | Yes | Level01 | Entry_vld | |
| [31:17] | | RsvdP | No | Level0 | | |
| End | | | | | | DFFCh |

### 2.3.4 DLUT Route Lookup

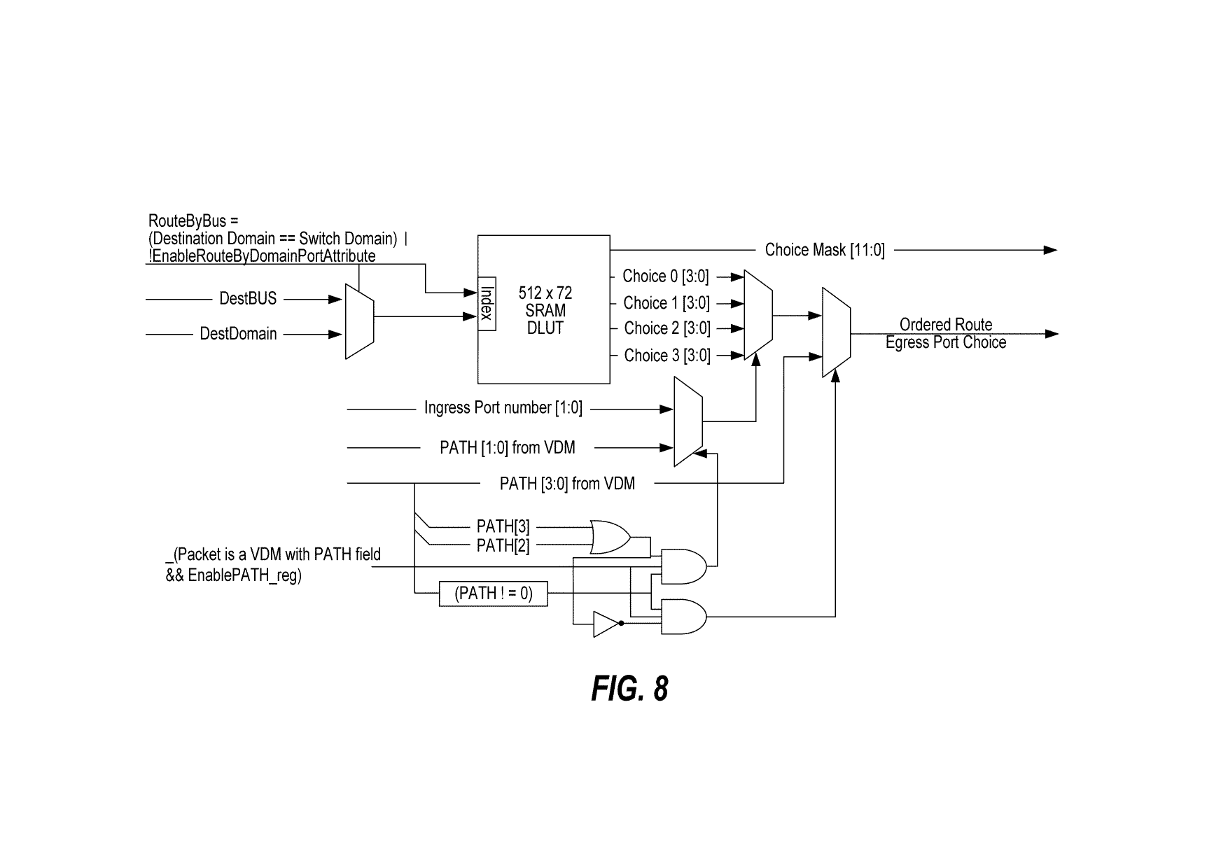

FIG. 8 illustrates a CH-DLUT route lookup in accordance with an embodiment. The Current Hop Destination LUT (CH-DLUT) mechanism, shown in FIG. 8, is used both when the packet is not yet in its Destination Domain, provided routing by Domain is not enabled for the ingress port, and at points where multiple paths through the fabric exist to the Destination BUS within that Domain, where none of the routing traps have hit. The EnableRouteByDomain port attribute can be used to disable routing by Domain at ports where this is inappropriate due to the fabric topology.

A 512 entry CH-DLUT stores 4 4-bit egress port choices for each of 256 Destination BUSes and 256 Destination Domains. The number of choices stored at each entry of the DLUT is limited to four in our first generation product to reduce cost. Four choices is the practical minimum, 6 choices corresponds to the 6 possible directions of travel in a 3D Torus, and eight choices would be useful in a fabric with 8 redundant paths. Where there are more redundant paths than choices in the CH-DLUT output, all paths can still be used by using different sets of choices in different instances of the CH-DLUT in each switch and each module of each switch.

Since the Choice Mask or masked choice vector has 12 bits, the number of redundant paths is limited to 12 in this initial silicon, which has 24 ports. A 24 port switch is suitable for use in CLOS networks with 12 redundant paths. In future products with higher port counts, a corresponding increase in the width of the Choice Mask entries will be made.

The Route by BUS is true when (Switch Domain==Destination Domain) or if routing by Domain is disabled by the ingress port attribute. Therefore, if the packet is not yet in its Destination Domain, then the route lookup is done using the Destination Domain rather than the Destination Bus as the D-LUT index, unless prohibited by the ingress port attribute.

In one embodiment, the CH-DLUT lookup provides four egress port choices that are configured to correspond to alternate paths through the fabric for the destination. DMA WR VDMs include a PATH field for selecting among these choices. For shared I/O packets, which don't include a PATH field or when use of PATH is disabled, selection among those four choices is made based upon which port the packet being routed entered the switch. The ingress port is associated with a source port and allows a different path to be taken to any destination for different sources or groups of sources.

The primary components of the CH-DLUT are two arrays in the per station BARO memory mapped register space of the GEP shown in the table below.

Table 3 illustrates CH-DLUT Arrays in Register Space

| | Default | | | | | |
|---|---|---|---|---|---|---|
| | Value | Attribute | EEPROM | Reset | Register or Field | |
| Offset | (hex) | (MCPU) | Writable | Level | Name | Description |
| Array | 256 | | | | | D-LUT table for 256 Domains |
| 800h | | | | | DLUT_DOMAIN_0 | D-LUT table entry for Domain 0 |
| [3:0] | 0 | RW | Yes | Level01 | Choice_0 | Valid values: 0-11; choice of 0xf implies |
| | | | | | | broadcast TLP - replicated to all stations |
| [7:4] | 3 | RW | Yes | Level01 | Choice_1 | Valid values: 0-11; choice of 0xf implies |
| | | | | | | broadcast TLP - replicated to all stations |
| [11:8] | 3 | RW | Yes | Level01 | Choice_2 | Valid values: 0-11; choice of 0xf implies |
| | | | | | | broadcast TLP - replicated to all stations |
| [15:12] | 3 | RW | Yes | Level01 | Choice_3 | Valid values: 0-11; choice of 0xf implies |
| | | | | | | broadcast TLP - replicated to all stations |
| [27:16] | 0 | RW | Yes | Level01 | Fault_vector | 1 bit per choice (12 choices); 0 = no fault; |
| | | | | | | 1 = fault for that choice - so avoid this |
| | | | | | | choice. |
| [31:28] | 0 | RsvdP | No | Level01 | Reserved | |
| End | | | | | | BFCh |
| Array | 256 | | | | | D-LUT Table for 256 destination busses |
| C00h | | | | | DLUT_BUS_0 | D-LUT table entry for Destination Bus 0 |
| [3:0] | 0 | RW | Yes | Level01 | Choice_0 | Valid values: 0-11; choice of 0xf implies |
| | | | | | | broadcast TLP - replicated to all stations |
| [7:4] | 3 | RW | Yes | Level01 | Choice_1 | Valid values: 0-11; choice of 0xf implies |
| | | | | | | broadcast TLP - replicated to all stations |
| [11:8] | 3 | RW | Yes | Level01 | Choice_2 | Valid values: 0-11; choice of 0xf implies |
| | | | | | | broadcast TLP - replicated to all stations |
| [15:12] | 3 | RW | Yes | Level01 | Choice_3 | Valid values: 0-11; choice of 0xf implies |
| | | | | | | broadcast TLP - replicated to all stations |
| [27:16] | 0 | RW | Yes | Level01 | Fault_vector | 1 bit per choice (12 choices); 0 = no fault; |
| | | | | | | 1 = fault for that choice - so avoid this |
| | | | | | | choice. |
| [31:28] | 0 | RsvdP | Yes | Level01 | Reserved | |
| End | | | | | | FFCh |

For host-to-host messaging, Vendor Defined Messages (VDMs), if use of PATH is enabled, then it can be used in either of two ways:
1) For a fat tree fabric, CH-DLUT Route Lookup is used on switch hops leading towards the root of the fabric. For these hops, the route choices are destination agnostic. The present embodiment supports fat tree fabrics with 12 branches. If the PATH value in the packet is in the range 0 . . . 11, then PATH itself is used as the Egress Port Choice; and
2) If PATH is in the range 0xC . . . 0xF, as would be appropriate for fabric topologies other than fat tree, then PATH[1:0] are used to select among the four Egress Port Choices provided by the CH-DLUT as a function of Destination BUS or Domain.

Note that if use of PATH isn't enabled, if PATH==0, or the packet doesn't include a PATH, then the low 2 bits of the ingress port number are used to select among the four Choices provided by the DLUT

In one embodiment, DMA driver software is configurable to use appropriate values of PATH in host to host messaging VDMs based on the fabric topology. PATH is intended for routing optimization in HPC where a single, fabric-aware application is running in distributed fashion on every compute node of the fabric.

In one embodiment, a separate array (not shown in FIG. 8), translates the logical Egress Port Choice to a physical port number.

### 2.3.5 Unordered Route

The CH-DLUT Route Lookup described in the previous subsection is used only for ordered traffic. Ordered traffic consists of all host < >I/O device traffic plus the Work Request VDM and some TxCQ VDMs of the host to host messaging protocol. For unordered traffic, we take advantage of the ability to choose among redundant paths without regard to ordering. Traffic that is considered unordered is limited to types for which the recipients can tolerate out of order delivery or for which re-ordering is implemented at the destination node. In one embodiment, unordered traffic types include only:
1) Completions (BCM bit set) for NIC and RDMA pull protocol remote read request VDMs. In one embodiment, the switches set the BCM at the host port in which completions to a remote read request VDM enter the switch.
2) NIC short packet push WR VDMs;
3) NIC short packet push TxCQ VDMs;
4) Remote Read request VDMs; and
5) (option) PIO write with RO bit set

Choices among alternate paths for unordered TLPs are made to balance the loading on fabric links and to avoid congestion signaled by both local and next hop congestion feedback mechanisms. In the absence of congestion feedback, each source follows a round robin distribution of its unordered packets over the set of alternate egress paths that are valid for the destination.

The CH-DLUT includes an Unordered Route Choice Mask for each destination BUS and Domain. In one embodiment, choices are masked from consideration by the Unordered Route Choice Mask vector output from the DLUT for the following reasons:
1) The choice doesn't exist in the topology;
2) Taking that choice for the current destination will lead to a fabric fault being encountered somewhere along the path to the destination; and
3) Taking that choice creates a credit cycle, which can lead to deadlock;

It also is helpful in grid like fabrics where switch hops between the home Domain and the Destination Domain may be made at multiple switch stages along the path to the destination to process the route by Domain route Choices concurrently with the Route by BUS Choices and to defer routing by Domain at some fabric stages for unordered traffic if congestion is indicated for its route Choices and not for route by BUS route Choices. This deferment of route by Domain due to congestion feedback would be allowed for the first switch to switch hop of a path and would not be allowed if the route by Domain step is the last switch to switch hop required.

The Unordered Route Choice Mask Table shown below is part of the DLUT and appears in the per-chip BARO memory mapped register space of the GEP.

| | Default | | | | | |
|---|---|---|---|---|---|---|
| | Value | Attribute | EEPROM | Reset | | |
| Offset | (hex) | (MCPU) | Writable | Level | Register or Field Name | Description |
| Array | 256 | | | | | |
| F0200h | | | | | Unordered | |
| | | | | | ROUTE_CHOICE_MASK | |
| [23:0] | | RW | Yes | Level01 | Route_choice_mask | if set, the corresponding port |
| | | | | | | to be avoided for routing to |
| | | | | | | the destination bus or |
| | | | | | | domain |
| [31:24] | | RsvdP | No | Level0 | Reserved | |
| End | | | | | | F05FCh |

In a fat tree fabric, the unordered route mechanism is used on the hops leading toward the root (central switch rank) of the fabric. Route decisions on these hops are destination agnostic. Fabrics with up to 12 choices at each stage are supported. During the initial fabric configuration, the Unordered Route Choice Mask entries of the CH-DLUTs are configured to mask out invalid choices. For example, if building a fabric with equal bisection bandwidth at each stage and with x8 links from a 97 lane Capella 2 switch, there will be 6 choices at each switch stage leading towards the central rank. All the Unordered Route Choice Mask entries in all the fabric D-LUTs will be configured with an initial, fault-free value of 12′hFCO to mask out choices 6 and up.

Separate masks are used to exclude congested local ports or congested next hop ports from the round robin distribution of unordered packets over redundant paths. A congested local port is masked out independent of destination. Masking of congested next hop ports is a function of destination. Next hop congestion is signaled using a DLLP with encoding as RESERVED as a Backwards Explicit Congestion Notification (BECN). BECNs are broadcast to all ports one hop backwards towards the edge of the fabric. Each BECN includes a bit vector indicating congested downstream ports of the switch generating the BECN. The BECN receivers use lookup tables to map each congested next hop port indication to the current stage route choice that would lead to it.

The routing of an unordered packet is a four step process:
Look up the Unordered Route Choices in the CH DLUT
Look up the next hop route egress ports associated with each of those current hop route choices in the NH DLUT (next hop DLUT)
   a. The NH DLUT gives the egress ports at the next route stage that lead to the destination for each of the current hop route choices
Look up the congestion associated with both first and second stage route choices using the result of the NH DLUT lookup
Make final route decision based on the congestion information

### CH DLUT Output Format

For the unordered route, the CH DLUT stores a 12-bit Unordered Route Choice Mask Vector for each potential destination Bus and destination Domain. The implicit assumption in the definition is that each of the choices in the vector is valid unless masked. The starting point for configuration is to assert all the bits corresponding to choices that don't exist in the topology. If a fault arises during operation, additional bits may be asserted to mask off choices affected by the fault. For example, a 3×3 array Clos network made with PEX9797 has only 3 valid choices corresponding to the fabric ports that lead to the three central rank switch in the array. To be clear: zero bits in the vector indicate that the associated ports are valid choices.

### NH DLUT Output Format

The NH DLUT is 512×96 array. For each possible destination Bus and Destination Domain, it returns 12 bytes of information. Each byte is associated with the same numbered bit of the Unordered Route Choice Mask Vector. Each byte is structured as a 2-bit pointer to one of four “Port of Choice” tables followed by a 6-bit “Choice” vector. The “Port of Choice” tables map bits in the vector to ports on the next hop switch. Next Hop route choices are stored at index values 256-511 in the next hop DLUT for destination Busses in the current Domain and at index values 0-255 for remote Domain destinations.

The “Port of Choice” tables return the ports on the next hop switch that lead to the destination if the associated current hop route choice is selected. It's those ports for which the congestion state is needed. It can be seen that this supports fabrics in which up to 6 next hop ports lead to the destination. The topology analysis in the next subsection shows that this is more than sufficient.

The “Port of Choice” tables are used to transform NH DLUT output from a next hop masked choice vector to a next hop masked port vector.

The next hop masked port vector aligns bit by bit with the next hop congestion vectors. They are in effected ANDed bit by bit with the congestion vectors so that only bits corresponding to next hop ports that lead to the destination for which congestion is indicated are asserted in the bit vector that results from the AND operation.

In order to do this, the “Port of Choice” tables and the Choice vectors themselves must be configured consistently with the fabric topology and the congestion vectors. The congestion vector bits are in port order; i.e. bit zero of the vector corresponds to port zero, etc. Since the is only one set of four Port of Choice tables but as many as 12 next hop switches from which congestion feedback is received, all the next hop switches must use the same numbered port to get to the same destination switch of a Clos network or to the equivalent next hop destination of a deeper fat tree or mesh network. For example, if port 0 of one central rank Clos network leads to destination switch 0, then the fabric must be wired so that port zero leads to destination switch 0 on all switches in the central rank. This is a fabric wiring constraint which if not followed makes the next hop congestion feedback unusable to the extent that it isn't followed.

### Topology Analysis

This NH DLUT route structure supports all fabric topologies with up to 24 next hop route choices in which only a single next hop route choice leads to the destination and some fabric topologies in which multiple next hop route choices lead to the destination.

The CH DLUT supports fabrics with up to 12 current hop route choices and up to 24 next hop route choices. Support for 12 first hop route choices and 24 2^{nd} hop route choices is consistent with C2's maximum of 24 fabric ports and the desire to support fat tree topologies.

The fabric topology determines how many first and second hop route choices lead to the destination:
1^{st} Order Mesh
   Up to 12 first hop choices, assuming a random/round-robin first hop and x8 fabric links
   Up to 12 2^{nd} hop route choices
   Only one 2^{nd} hop route choice leads to the destination
   Two Port of Choice tables are needed and configured to map the ports in two contiguous blocks of 6 corresponding to the congestion vectors
   Choice vectors will be one-hot
Clos Network
   Up to 12 first hop route choices
   Up to 24 2^{nd} hop route choices
   Only one 2^{nd} hop route choice leads to the destination
   Four Port of Choice tables needed and configured to map the ports in four contiguous blocks of six corresponding to the congestion vectors
   Choice vectors will be one-hot
2^{nd} Order Flattened Butterfly
   Up to 9 first hop route choices (random/RR first hop) on a 5×5 array with x8 fabric links, which is the maximum non-blocking, deadlock free, configuration for 96 lane switches
   Up to two 2^{nd} hop route choices (on minimum path) from a total of 9 choices
   Only a single 3^{rd} hop route choice, again from a total of 9 choices
   The third hop congestion isn't visible when making the first hop route decision
   This topology is problematic because there are 9 choices at each stage but the NH DLUT allows next hop port values to be looked up for only 6 ports per destination.
   Choice vectors at the first hop will be two-hot
2D Torus
   4 route choices at every stage
   At most 2 of them move packet towards/closer to destination on a cycle free path
   Any number of hops required to reach destination
   A single Port of Choice table suffices
   Choice vectors will be two hot
3D Torus
   6 route choices at every stage
   At most 3 of them move packet towards/closer to destination on a cycle free path
   Any number of hops required to reach destination
   Choice vectors will be three hot

Improved support for topologies with multiple next hop route choices can be realized by implementing options to interpret the NH DLUT output differently:
For >3 stage fat tree, 12-bit NH DLUT choice vectors are required. This can be realized by realizing the NH DLUT in an array that is half as deep and twice as wide—256×192. With that change, 12 bit choice vectors can be supported for half as many destinations. Two of the 6-entry port of choice tables would be combined to form a single 12 entry table for this option.
For 2^{nd} order flattened butterfly fabrics, 9-bit two hot choice vectors are required. This can be realized by interpreting the 512×(12×8) array as a 512×(10×9) array. This would be used with a single 10-entry Port of Choice table.

### Congestion Array

A copy of the congestion information is maintained in every “station” module of the switch as the information is needed at single clock latency for routing decisions. The information is stored in discrete flip-flops organized as a set of Next Hop Congestion Vectors for each fabric port of the current switch, as shown in FIG. 12. Separate congestion vectors are maintained for low and medium priority traffic. The next hop congestion information is communicated from switch to switch using Vendor Defined DLLP and distributed within each switch using a ring interconnect as specified in subsequent subsections.

### Congestion Based Route Decisions

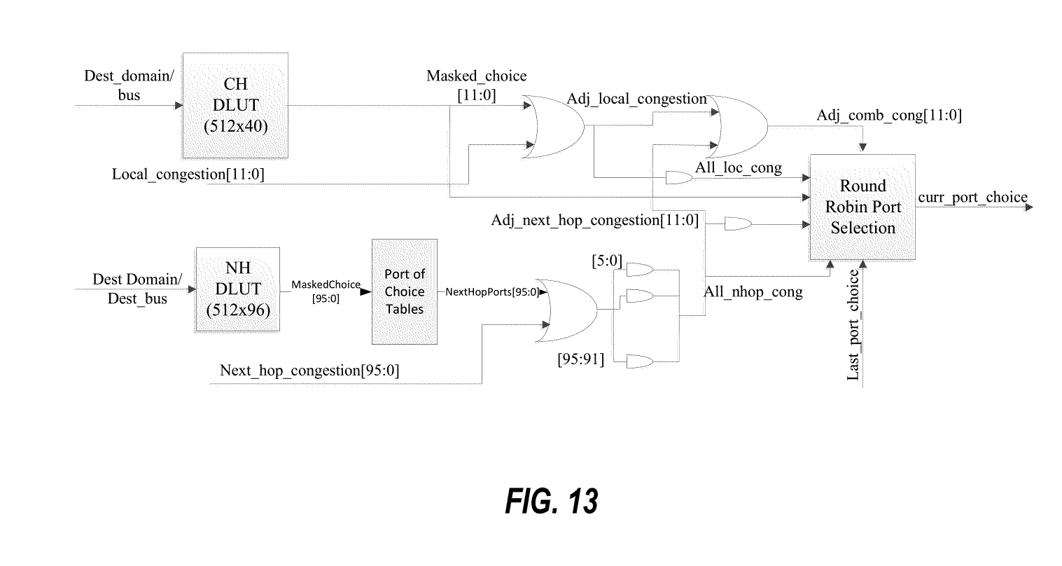

FIG. 13 illustrates the logic for selecting a particular egress port when routing an unordered TLP. This is a simplified block diagram doesn't illustrate use of the Port of Choice tables or how differential treatment is provided for high, low and medium priority traffic.

The final congestion vector is generated using these rules:
If all current hop unordered route choices are congested then the congestion feedback is ignored and a final selection is made by round robin among the Unordered Route Choice Mask vector, the output of the CH DLUT.
If there is only a single Unordered Route Choice for which no congestion is indicated, then it is selected.
If there are multiple Unordered Route Choices for which no congestion is indicated, then a selection among the uncongested choices is made by round robin.

### Round-Robin Tie Breaking

In the above, a round robin policy was specified for use breaking ties in the complete absence of congestion indications and when congestion is indicated for all route choices. The simplest round robin policy is to send packets to each route choice in order, independent of what flow, if any, it might be a part of. This is what has been implemented in Capella 2.

It was shown earlier that for several topologies of interest, our BECN doesn't make all congestion along all complete paths through the fabric visible at the source edge node where the initial routing decision is made. Furthermore, reactive congestion management mechanisms are limited in their effectiveness by delays in the congestion sensing and feedback paths. For fabrics with more than 3 stages and for improved performance on 3 stage fabrics, a proactive congestion management mechanism is desirable.

Deeper fabrics are likely better served with a feed forward mechanism rather than a feedback mechanism because the delay in the feedback loop may approach or exceed the amount of congestion buffering available if the BECNs were sent back all the way to the source edge switches. It is well known that a round robin per flow current hop routing policy that rounds over multiple first hop route choices will balance the fabric link loading at the next hop stages. Depending on the burstiness of the traffic, switch queues may fill before balance occurs. Thus even with round robin per flow, congestion feedback remains necessary.

Given the limited goal of load balancing paths at the next switch stage, the round robin per flow policy can be simplified to what is essentially round robin per destination edge switch. Each stream from any input visible to the management logic (in each switch “station”) to each destination is treated as a separate flow. This is the coarsest grained possible flow definition and will thus require the least time for loads to balance. It also requires the least state storage.

Implementing this policy with the flexibility to adapt to different switch port configuration and fabric topologies can be done with a two stage lookup of the flow state, as illustrated in FIG. 16.
The first stage converts the Destination Bus or Domain, depending upon which is being used for routing at the current stage, to a Destination Switch number. A 512×6 array supports fabrics with up to 64 edge switches, which is well beyond rack scale. A 512×8 would provide a significant degree of future proofing.
The 2^{nd} stage uses the Destination Switch number to index a (e.g.) 64×4 Prior Choice Array. The Prior Choice Array should be initialed with either cyclic or pseudo-random values so that traffic towards each destination switch starts at a different point in the round. Each table entry indicates the most recent Current Hop Route Choice taken for the destination associated with the table index. The flow state table entry for a flow is updated for all packets that are forwarded, regardless of whether they are classified as ordered or unordered.

With round robin per destination edge switch differs from the simple round robin policy described earlier only in that a separate round robin state is maintained for each destination edge switch. Note that the Destination Switch LUT and Prior Choice Array are together quite small compared to the CH and NH DLUTs.

One routes the next unordered packet in a flow (to a specific destination edge switch) to the next Choice in the Current Hop Unordered Route Choice vector after that listed in the flow state table. As noted earlier, if all such Choices are congested or if more than one is uncongested, the next choice, starting from the most recent choice taken to that direction, in increasing bit order on the choice vector is taken.

After each such route, the choice just taken is written to the destination's entry in the Prior Choice Array.

Tie breaking via round robin per destination edge switch is proposed as an improvement for the next generation fabric switch. This was rejected initially as being too complicated but, as should be evident, the next hop congestion feedback that we ended up implementing is considerably more complicated. In retrospect, the two methods complement each other with each compensating for the shortcomings of the other. Adding round robin per destination edge switch at this point is only a marginal increase in cost and complexity.

### Local Congestion Feedback

Fabric ports indicate congestion when their fabric egress queue depth is above a configurable threshold. Fabric ports have separate egress queues for high, medium, and low priority traffic. Congestion is never indicated for high priority traffic; only for low and medium priority traffic.

Fabric port congestion is broadcasted internally from the fabric ports to all the ports in the switch. using congestion ring bus for each {port, priority}, where priority can be medium or low. When a {port, priority} signals XOFF in the congestion ring bus, then edge ingress ports are advised not to forward unordered traffic to that port, if possible. If, for example, all fabric ports are congested, it may not be possible to avoid forwarding

Hardware converts the portX local congestion feedback to a local congestion bit vector per priority level, one vector for medium priority and one vector for low priority. High priority traffic ignores congestion feedback because by virtue of its being high priority, it bypasses traffic in lower priority traffic classes, thus avoiding the congestion. These vectors are used as choice masks in the unordered route selection logic, as described earlier.

For example, if a local congestion feedback from portX uses choice 1 and 5 and has XOFF set for low priority, then bits[1] and [5] of low local_congestion would be set. If a later local congestion from portY has XOFF clear for low priority, and portY uses choice 2, then bit[2] of low_local_congest would be cleared.

If all valid (legal) choices are locally congested, i.e. all 1s, the local congestion filter applied to the legal_choices is set to all Os since we have to route the packet somewhere.

In one embodiment, any one station can target any of the six stations on a chip. Put another way, there is a fan-in factor of six stations to any one port in a station. A simple count of traffic sent to one port from another port cannot know what other ports in other stations sent to that port and so may be off by a factor of six. Because of this, one embodiment relies on the underlying round robin distribution method augmented by local congestion feedback to balance the traffic and avoid hotspots.

The hazard of having multiple stations send to the same port at the same time is avoided using the local congestion feedback. Queue depth reflects congestion instantaneously and can be fed back to all ports within the Inter-station Bus delay. In the case of a large transient burst targeting one queue, that Queue depth threshold will trigger congestion feedback which allows that queue time to drain. If the queue does not drain quickly, it will remain XOFF until it finally does drain.

Each source station should have a different choice_to_port map so that as hardware sequentially goes through the choices in its round robin distribution process, the next port is different for each station. For example, consider x16 ports with three stations 0,1,2 feeding into three choices that point to ports 12, 16, 20. If port 12 is congested, each station will cross the choice that points to port 12 off of their legal choices (by setting a choice_congested [priority]). It is desirable to avoid having all stations then send to the same next choice, i.e. port 16. If some stations send to port 16 and some to port 20, then the transient congestion has a chance to be spread out more evenly. The method to do this is purely software programming of the choice to port vectors. Station0 may have choice 1,2,3 be 12, 16, 20 while stationl has choice 1,2,3 be 12, 20, 16, and station 2 has choice 1,2,3 be 20, 12, 16.

A 512 B completion packet, which is the common remote read completion size and should be a large percent of the unordered traffic, will take 134 ns to sink on an x4, 67 ns on x8, and 34.5 ns on x16. If we can spray the traffic to a minimum of 3× different x4 ports, then as long as we get feedback within 100 ns or so, the feedback will be as accurate as a count from this one station and much more accurate if many other stations targeted that same port in the same time period.

### Next Hop Congestion

For a switch from which a single port leads to the destination, congestion feedback sent one hop backwards from that port to where multiple paths to the same destination may exist, can allow the congestion to be avoided. From the point of view of where the choice is made, this is next hop congestion feedback.

For example, in a three stage Fat Tree, CLOS network, the middle switch may have one port congested heading to an edge switch. Next hop congestion feedback will tell the other edge switches to avoid this one center switch for any traffic heading to the one congested port.

For a non-fat tree, the next hop congestion can help find a better path. The congestion thresholds would have to be set higher, as there is blocking and so congestion will often develop. But for the traffic pattern where there is a route solution that is not congested, the next hop congestion avoidance ought to help find it.

Hardware will use the same congestion reporting ring as local feedback, such that the congested ports can send their state to all other ports on the same switch. A center switch could have 24 ports, so feedback for all 24 ports is needed

If the egress queue depth exceeds TOFF ns, then an XOFF status will be sent. If the queue drops back to TON ns or less, then an XON status will be sent. These times reflect the time required to drain the associated queue at the link bandwidth.

When TON<TOFF, hysteresis in the sending of BECNs results. However, at the receiver of the BECN, the XOFF state remains asserted for a fixed amount of time and then is de-asserted. This “auto XON” eliminates the need to send a BECN when a queue depth drops below TON and allows the TOFF threshold to be set somewhat below the round trip delay between adjacent switches.

For fabrics with more than three stages, next hop congestion feedback may be useful at multiple stages. For example, in a five stage Fat Tree, it can also be used at the first stage to get feedback from the small set of away-from-center choices at the second stage. Thus, the decision as to whether or not to used next hop congestion feedback is both topology and fabric stage dependent.

a PCIe DLLP with encoding as Reserved is used as a BECN to send next hop congestion feedback between switches. Every port that forwards traffic away from the central rank of a fat tree fabric will send a BECN if the next hop port stays in XOFF state. It is undesirable to trigger it too often.

### BECN Information

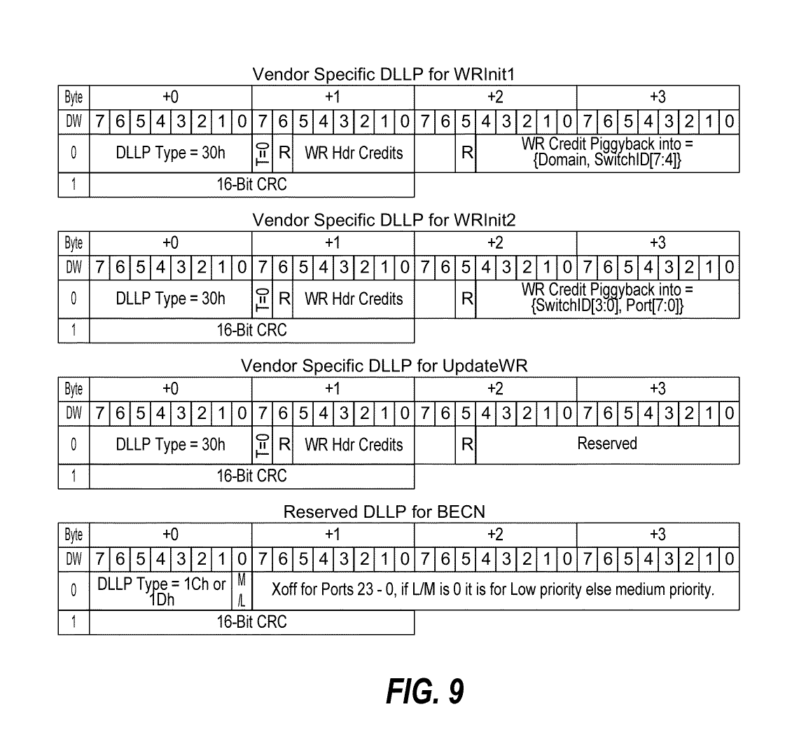

FIG. 9 illustrates a BECN packet format. BECN stands for Backwards Explicit Congestion Notification. It is a concept well known in the industry. Our implementation uses a BECN with a 24-bit vector that contains XON/XOFF bit for every possible port. BECNs are sent separately for low priority TC queues and medium priority TC queues. BECNs are not sent for high priority TC queues, which theoretically cannot congest.

BECN protocol uses the auto_XON method described earlier. A BECN is sent only if at least one port in the bit vector is indicating XOFF. XOFF status for a port is cleared automatically after a configured time delay by the receiver of a BECN. If a received BECN indicates XON, for a port that had sent an XOFF in the past which has not yet timed out, the XOFF for that port is cleared.

The BECN information needs to be stored by the receiver. The receiver will send updates to the other ports in its switch via the internal congestion feedback ring whenever a hop port's XON/XOFF state changes.

Like all DLLPs, the Vendor Defined DLLPs are lossy. If a BECN DLLP is lost, then the congestion avoidance indicator will be missed for the time period. As long as congestion persists, BECNs will be periodically sent.

### BECN Receiver

Any port that receives a DLLP with new BECN information will need to save that information in its own XOFF vector. The BECN receiver is responsible to track changes in XOFF and broadcast the latest XOFF information to other ports on the switch. The congestion feedback ring is used with BECN next hop information riding along with the local congestion.

Since the BECN rides on a DLLP which is lossy, a BECN may not arrive. Or, if the next hop congestion has disappeared, a BECN may not even be sent. The BECN receiver must take care of ‘auto XON’ to allow for either of these cases.

One important thing for a receiver to not turn XON a next hop if it should stay off. Lost DLLPs are so rare as to not be a concern. However, DLLPs can be stalled behind a TLP and they often are. The BECN receiver must tolerate a Tspread +/−Jitter range, where Tspread is inverse of the transmitter BECN rate and Jitter is the delay due to TLPs between BECNs.

Upon receipt of a BECN for a particular priority level, a counter will be set to Tspread+Jitter. If the counter gets to 0 before another BECN of any type is received, then all XOFF of that priority are cleared. The absence of a BECN implies that all congestion has cleared at the transmitter. The counter measures the worst case time for a BECN to have been received if it was in fact sent.

The BECN receiver also sits on the on chip congestion ring. Each time slot it gets on the ring, it will send out any state change information before sending out no-change. The BECN receiver must track state change since the last time the on chip congestion ring was updated. It sends the next hop medium and low priority congestion information for half the next hop ports per slot. The state change could be XOFF to XON or XON to XOFF. If there were two state changes or more, that is fine—record it as a state change and report the current value.

### Ingress TLP and BECN

The ports on the current switch that receive BECN feedback on the inner switch broadcast will mark a bit in an array as ‘off.’ The array needs to be 12 choices×24 ports.

A RAM with size 512×12 is needed to store fault vector of current hop where first 256 entries is for route by bus and remaining 256 is for route by domain. A ram with size 512×96(12×8) is needed for storing Next hop fault vector, where 8 bits is for each fabric port.

### EXAMPLE

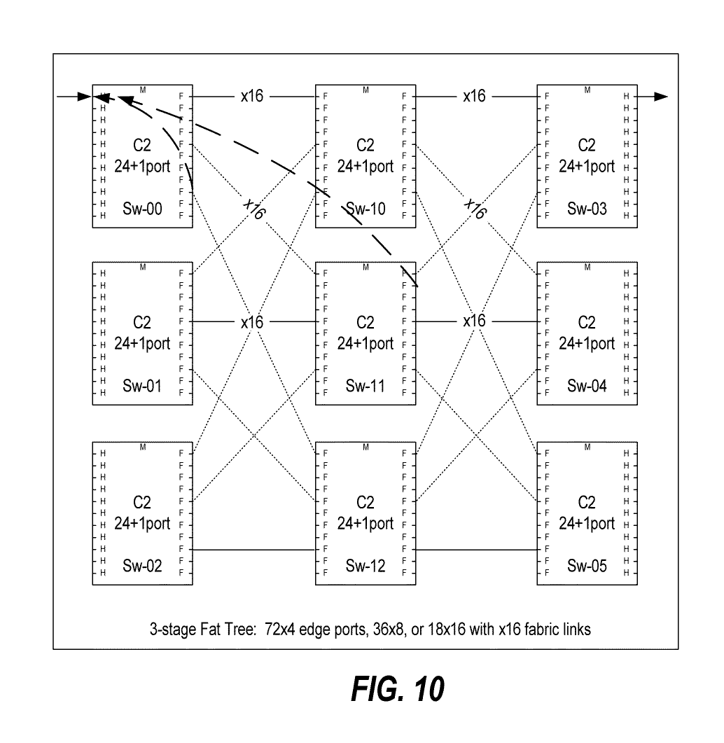

FIG. 10 illustrates a three stage Fat tree with 72×4 edge ports. Suppose that a TLP arrives in Sw-00 and is destined for destination bus DB which is behind Sw-03. There are three choices of mid-switch to route to, Sw-10, Sw-11, or Sw-12. However, the link from Sw-00 to Sw-12 is locally congested. Additionally Sw-11 port to Sw-03 is congested.

Sw-00 ingress station last sent an unordered medium priority TLP to Sw-10, so Sw-11 is the next unordered choice. The choices are set up as 1 to Sw-10, 2 to Sw-11, and 3 to Sw-12.

Case1: The TLP is an ordered TLP. D-LUT[DB] tells us to use choice1. Regardless of congestion feedback, a decision to route to choice1 leads to Sw-11 and even worse congestion.

Case2: The TLP is an unordered TLP. D-LUT[DB] shows that all 3 choices 1,2, and 3 are unmasked but 4-12 are masked off. Normally we would want to route to Sw-11 as that is the next switch to spray unordered medium traffic to. However, a check on NextHop[DB] shows that choice2's next hop port would lead to congestion. Furthermore choice3 has local congestion. This leaves one ‘good choice’, choice1. The decision is then made to route to Sw-10 and update the last picked to be Sw-10.

Case3: A new medium priority unordered TLP arrives and targets Sw-04 destination bus DC. D-LUT[DC] shows all 3 choices are unmasked. Normally we want to route to Sw-11 as that is the next switch to spray unordered traffic to. NextHop[DC] shows that choice2's next hop port is not congested, choice2 locally is not congested, and so we route to Sw-11 and update the last routed state to be Sw-11.

### Route Choice to Port Mapping

The final step in routing is to translate the route choice to an egress port number. The choice is essentially a logical port. The choice is used to index table below to translate the choice to a physical port number. Separate such tables exist for each station of the switch and may be encoded differently to provide a more even spreading of the traffic.

TABLE 5
Route Choice to Port Mapping Table
DMA Work Request Flow Control

| | Default | | | | | |
|---|---|---|---|---|---|---|
| | Value | Attribute | EEPROM | Reset | | |
| Offset | (hex) | (MCPU) | Writable | Level | Register or Field Name | Description |
| 1000h | | | | | Choice_mapping_0_3 | Choice to port |
| | | | | | | mapping entries for |
| | | | | | | choices 0 to 3 |
| [4:0] | 0 | RW | Yes | Level01 | Port_for_choice_0 | |
| [7:5] | 0 | RsvdP | No | Level01 | Reserved | |
| [12:8] | 0 | RW | Yes | Level01 | Port_for_choice_1 | |
| [15:13] | 0 | RsvdP | No | Level01 | Reserved | |
| [20:16] | 0 | RW | Yes | Level01 | Port_for_choice_2 | |
| [23:21] | 0 | RsvdP | No | Level01 | Reserved | |
| [28:24] | 0 | RW | Yes | Level01 | Port_for_choice_3 | |
| [31:29] | 0 | RsvdP | No | Level01 | Reserved | |
| 1004h | | | | | Choice_mapping_4_7 | Choice to port |
| | | | | | | mapping entries for |
| | | | | | | choices 4 to 7 |
| [4:0] | 0 | RW | Yes | Level01 | Port_for_choice_4 | |
| [7:5] | 0 | RsvdP | No | Level01 | Reserved | |
| [12:8] | 0 | RW | Yes | Level01 | Port_for_choice_5 | |
| [15:13] | 0 | RsvdP | No | Level01 | Reserved | |
| [20:16] | 0 | RW | Yes | Level01 | Port_for_choice_6 | |
| [23:21] | 0 | RsvdP | No | Level01 | Reserved | |
| [28:24] | 0 | RW | Yes | Level01 | Port_for_choice_7 | |
| [31:29] | 0 | RsvdP | No | Level01 | Reserved | |
| 1008h | | | | | Choice_mapping_11_8 | Choice to port |
| | | | | | | mapping entries for |
| | | | | | | choices 8 to 11 |
| [4:0] | 0 | RW | Yes | Level01 | Port_for_choice_8 | |
| [7:5] | 0 | RsvdP | No | Level01 | Reserved | |
| [12:8] | 0 | RW | Yes | Level01 | Port_for_choice_9 | |
| [15:13] | 0 | RsvdP | No | Level01 | Reserved | |
| [20:16] | 0 | RW | Yes | Level01 | Port_for_choice_10 | |
| [23:21] | 0 | RsvdP | No | Level01 | Reserved | |
| [28:24] | 0 | RW | Yes | Level01 | Port_for_choice_11 | |
| [31:29] | 0 | RsvdP | No | Level01 | Reserved | |

In ExpressFabric™, it is necessary to implement flow control of DMA WR VDMs in order to avoid deadlock that would occur if a DMA WR VDM that could not be executed or forwarded, blocked a switch queue. When no WR flow control credits are available at an egress port, then no DMA WR VDMs may be forwarded. In this case, other packets bypass the stalled DMA WR VDMs using a bypass queue. It is the credit flow control plus the bypass queue mechanism that together allow this deadlock to be avoided.

In one embodiment, a Vendor Defined DLLP is used to implement a credit based flow control system that mimics standard PCIe credit based flow control. FIG. 10 illustrates an embodiment of Vendor Specific DLLP for WR Credit Update. The packet format for the flow control update is illustrated below. The WR Init 1 and WR Init 2 DLLPs are sent to initialize the work request flow control system while the UpdateWR DLLP is used during operation to update and grant additional flow control credits to the link partner, just as in standard PCIe for standard PCIe credit updates.

### Topology Discovery Mechanism

To facilitate fabric management, a mechanism is implemented that allows the management software to discover and/or verify fabric connections. A switch port is uniquely identified by the {Domain ID, Switch ID, Port Number} tuple, a 24-bit value. Every switch sends this value over every fabric link to its link partner in two parts during initialization of the work request credit flow control system, using the DLLP formats defined in FIG. 10. After flow control initialization is complete, the {Domain ID, Switch ID, Port Number} of the connected link partner can be found, along with Valid bits, in a WRC_Info_Rcvd register associated with the Port. The MCPU reads the connectivity information from the WRC_Info_Rcvd register of every port of every switch in the fabric and with it is able to build a graph of fabric connectivity which can then be used to configure routes in the DLUTs.

### EXAMPLE

For a fat tree with multiple choices to the root of the fat tree, the design goal is to use all routes. Unordered traffic should be able to route around persistent ordered traffic streams, such as caused by shared JO or ordered host to host traffic using a single path.

For a fat tree with multiple choices, one link may be degraded. The design goal is to recognize that weaker link and route around it. If a healthy fabric has 6× bandwidth using 3× healthy paths, then one path drops from 2× to 1×, then the resulting fabric should run at 5× bandwidth worst case. If software can lower the injection rate that uses the weak link to ⅚ of nominal, no congestion should develop in the fabric allowing other flows to run at 11/2=5.5× assuming uniform traffic load using different TxQ for each destination.

Blocking topologies will likely often have congestion. A 2D or 3D torus can benefit from local congestion avoidance to try a different path, if there is more than one choice. BECN next hop on a non-fat tree is possible only if we can define ‘BECN enable’ or not.

### A Good Choice

The design goal is for hardware to be able to make a good choice to avoid congestion using a set of legal paths. The choice need not be the best.

To even be considered a choice, there must be no faults anywhere on the path to the destination, i.e. the path must be valid. One must rule out use of a choice where the port selected on the first hop through a 3 stage fabric would cause the packet to encounter a fault on its second hop. A choice_mask or fault vector programmed in the D-LUT and Next hop choice mask (next hop masked choice vector) or fault vector in NH-DLUT or NHDLUTfor every possible destination bus or domain will give the legal paths (paths that are not masked).

After the choice_mask, the best choice would be the one that has little other traffic. Congestion feedback from the same switch egress and the next switch egress will help indicate which choices have heavy traffic and should be avoided, assuming another choice has less heavy traffic. Clearly if unordered traffic hits congestion, latency will go up. Not as clearly, unordered traffic hitting ordered congestion may cause throughput to drop unless unordered traffic can be routed around the congestion.

Putting it together, all valid choices (those not masked) will be filtered against a same switch congestion vector and a next hop congestion vector. The remaining choices are all good choices. A choice equation follows:

good_choices=!masked_choice & !adj_local_congestion & !adj_next_hop_congestion

selected_choice=state_machine (last choice[priority], good_choices)

Looking at the equations, the masked choice term is easy enough to understand: if the choice does not lead to the destination or should not be used, it will be masked. Masking may be due to a fault or due to a topology consideration where the path should not be used. The existence of a masked choice is a function of destination and thus requires a look up (D-LUT output).

The congestion filters each have two adjustments. First there is a priority adjustment. The TLP's TC will be used to determine which priority class the TLP belongs to. High priority traffic is never considered congested, but medium and low priority traffic could be congested. If low priority traffic is congested on a path but medium priority is not, medium priority traffic can still make low latency progress on the congested low latency path.

If medium priority traffic is congested, then theoretically low priority could make progress since it uses a different queue. However, practically we do not want low priority traffic to pile up on a congested medium priority path, so we will avoid it. For example, consider shared IO ordered traffic on medium priority taking up all the bandwidth − low priority host to host should use an alternate path if such a path exists. This avoidance is handled by hardware counting only medium + high traffic for medium congestion threshold checks, but counting high, medium and low traffic for low priority congestion threshold checks. The same threshold is used for both medium and low priority, so if medium priority is congested, then low priority is also congested. However, low priority can be congested without medium priority being congested.

The second adjustment is needed because one choice always must be made even if everything is congested. If the congestion vector mapped for all un-masked choices is all ls, then it is treated as if it were all 0s (i.e. no congestion).

The combination of priority and ignoring all-1s result in the adjusted congestion filter, either adj_local or adj_next_hop. For example, logic to determine the adj_local_congestion is as follows (similar logic for adj_next_hop_congestion):
low_local_all_one=&(low_local_congestion|masked_choice);
medum_local_all_one=&(medium_local_congestion|masked_choice);
all_one=(TC==high)|(TC==medium && medium_local_all_one)|(TC==low && low_local_all_one);
adj_local_congestion[11:0]=(all_one)? 12′b0
   : (TC==medium)? medium_local_congestion
   :low_local_congestion;

A choice is selected based on the most recent choice for the given priority level and the choices available. In the absence of the congestion feedback the unordered packet is routed based on purely round robin arbitration between all possible choices. A state machine will track the most recent choice for high, medium, and low priority TLPs separately.

The next sub-sections go into the mechanisms behind the equation: where do masked_choice, local_congest, and next_hop_congestion come from.

Chicken bit options should be available to turn off either local_congestion or next_hop_congestion independently.

### Unordered Route Choice Mask

The unordered route choice mask vector or fault vector is held in the CH-DLUT, which is indexed by either destination bus or destination domain. There are at most 12 unordered choices. Software will program a 1 in the choice mask vector for any choice to avoid for the destination bus (if same domain) or the domain (if different domain)

For a fat tree, all choices are equal. If there are only 3 choices or 6 choices, and not 12, then only 3 or 6 are programmed The remaining choices are turned off by labeling them as masked choices.

For other topologies, pruning can be applied with the choice mask vector. For example, a 3D torus can have up to 6 choices. Only 1, 2, or 3 will likely head closer to the target—the other choices can be pruned by setting a choice mask bit on them.

For the Argo box, it may be desirable to route traffic between the lower two switches only using the 2×16 links between the switches, and not take a detour through the top switch. This can be accomplished by programming a choice mask on the path to the top switch for those destinations on the other bottom switch.

### Egress Queue Depth

The egress scheduler is responsible for initiating all congestion feedback. It does so by determining its egress queue filled depth or fill level in nanoseconds.

The egress logic will add to the queue depth any time a new TLP arrives on the source queue. If the resolution is 16B and a header is defined to take 2 units, a 512 B CpID will therefore count as 2+512/16=34 units. A 124 B payload VDM-WR with a prefix will count as 2+128/16=10 units.

The egress logic will subtract from the queue depth any time a TLP is scheduled. The same units are used.

The units will then be scaled according to the egress port bandwidth. An x16 gen3 can consume 2 units per clock, whereas an x1 gen1 can only consume 1 unit in 64 clocks. The ultimate job of the egress scheduler is to determine if the Q-depth in ns is more than a programmable threshold Toff or Ton.

The same thresholds can be used for both low and medium priority. Low priority q-depth count should include low+medium+high priority TLPs (all of them). Medium priority q-depth should not include low priority TLPs, only medium and high priority. It is possible that a low priority threshold is reached but not a medium priority threshold. It should not be possible for a medium threshold to be reached but not a low priority threshold.

A port is considered locally congested if its egress queue has Toff or greater queue fill depth. Hysteresis will be applied so that a port stays off for a while before it turns back on; port will stay off until queue drops to Ton. Queue depth is measured in ns and the count for new TLPs should automatically scale as the link changes width or speed.

The output of the queue depth logic should be a low priority Xoff and a medium priority Xoff per port.

Management software should know to program local congestion values for Ton and Toff to be smaller than for next hop congestion. Hardware doesn't care; it will just use the value programmed for that port.

### Debug

It will be very valuable to see the count for the number of clocks the queue depth ranged between a min and max value. Software can sample the count every 1 sec quite easily, so the count should not saturate even if it counts every clock for 1s, which is 500M 2 ns clocks. A 32b counter is needed.

The debug would look at just one q-depth for a station.

### Station to Station Congestion Feedback Ring

Each station will track congestion to all ports on that same switch as well as to ports in the next hop. An internal station to station ring is used to send feedback between ports on the same switch. The congestion feedback ring protocol will have the following structure:

| | |
|---|---|
| 0 | Local port low priority Xoff. |
| 1 | Local port medium priority Xoff. |
| 6:2 | Local Port number. |
| 18:7 | Next hop low priority Xoff. |
| 30:19 | Next hop medium priority Xoff. |
| 31 | Low priority next hop low/high port. When 0, field [18:7] |
| | represents for next hop port number from 0 to 11. When 1, |
| | field [18:7] represents for next hop port number from 12 to 23. |
| 32 | Valid. Information on the bus is valid when this bit is set. |

All fabric ports will report on the congestion ring in a fixed sequential order. First station0 will send out a start pulse, which has local port=5′b11111 and valid=1. This starts the reporting sequence. Every station can use the receipt of the start pulse as a start/reset to sync up when it will send information on the congestion feedback ring (muxing its value onto the ring). Each station is provided 4 slots in the update cycle. The slot for the station is programmable with default value as:

| | | | |
|---|---|---|---|
| 4:0 | RW | Slot 0 for the station | Station_id *4 + 1 |
| 5 | RW | Valid - Slot is valid | 1′b1 |
| 7:6 | Rsvd | Reserved | 3′h0 |
| 12:8 | RW | Slot 1 for the station | Station_id *4 + 2 |
| 13 | RW | Valid - Slot is valid | 1′b1 |
| 15:14 | Rsvd | Reserved | 3′h0 |
| 21:16 | RW | Slot 2 for the station | Station_id *4 + 3 |
| 22 | RW | Valid - Slot is valid | 1′b1 |
| 24:23 | Rsvd | Reserved | 3′h0 |
| 28:24 | RW | Slot 3 for the station | Station_id *4 + 4 |
| 20 | RW | Valid - Slot is valid | 1′b1 |
| 31:30 | Rsvd | Reserved | 3′h0 |

The order at which at port puts the congestion information is decided by the slot number programmed by software. By default the sequence is Station 0→Station1→Station2 - - - →Station 5.

### Transmitter to On Chip Congestion Ring

A fabric port pointing to the center will send both local and BECN next hop congestion information on the congestion ring. Only fabric ports participate in the congestion ring feedback. EEPROM or management software will program, per station, the slots used on the ring. Up to 24 ports could use the ring, but if only 3 fabric ports are active then only 3 slots will be programmed, reducing the latency to get access to the ring.

A port will determine its slot offset from the start strobe based on the 4 registers in the station.

P0_ring_slot[5b]

P1_ring_slot[5b]

P2_ring_slot[5b]

P3_ring_slot[5b]

An x8 fabric port would use 2 slots, either 0-1 or 2-3, depending on the port location. An x16 would use all 4 slots. An x4 would use the correct 1 slot. The start strobe uses slot 0. So if a port is programmed to ring_slot=1, it would follow the start strobe. If programmed to ring_slot=10, it would follow 10 clocks after the start strobe.

The BECN next hop information can cover low and medium priority for up to 24 ports. If we serially report each of those changes, the effect will be dreadfully slow. Instead of one bit reported at a time, we will report multiple ports at once using a similar bit vector as the BECN 2x12b will tell the on/xoff for 12 ports for medium and low priority. Another 1b will tell which the ports are in: bottom half or top half.

A fabric port pointing away from center will not have received next hop information, so it will send all 0s on the Next Hop fields. Only local congestion fields will be non-0. This local congestion information is actually the basis used to send next hop congestion on other fabric ports pointing away from the center on the same switch! Basically a port uses its own threshold logic to report local congestion on the ring and it uses BECN received data to report next hop congestion on the ring. No BECN received means no next hop data to report.

A non-fabric port will not send any congestion information on the ring. Instead, it can send the same data as the previous clock, except setting valid to 0, to reduce power.

### Receiver on On Chip Congestion Ring

All stations will monitor the on chip congestion ring.

The local congestion feedback is saved in two places.

First, it is saved in a local congestion bit vector. The local port is associated with the choice to port array. Any match (could be more than 1 choice pointing to the same port) will result in a 1 set on the congestion_apply 12b vector. The congestion_data vector is then used as a mask to apply to the local_congestion vector for either medium or low priority as follows:

This is how congestion vector is stored:

We have total 600 bits where 300 bits is for medium and low priority each. The 12 bits is local congestion information and 24 bits are for each fabric port next hop information which in total makes 12×24=288 bits. By using the following formula we derive final 12 bit vector and choose one of the fabric port based on last selection:
Final_xoff[11:0]=(local_xoff & local_mask) & [(next_hop_xoff_11 & next_hop_mask_11), . . . ,(next_hop_xoff_0 & next_hop_mask_0)]
Port number to route is
Port_to_chooce [RR [final_xoff[11:0]]]
The above equation is applied for both low and medium priority.

For a case where a next hop is using both domain and source to route packets, such as a Top of Rack switch with local domain connections and inter-domain connections, there should only be 1 choice for the local domain connections and so Next Hop congestion feedback will not do anything. While the next hop feedback is accurate for choice x next_hop_port, the NH_LUT index may not be. To avoid any confusion, a NH_LUT_domain bit will tell hardware to only read the NH_LUT for cases where the TLP targets a different domain if 1, else the NH_LUT will be read only for cases where a TLP targets the same domain.

### Debug

It may be useful to see the congestion state via inline debug. Each of the recorded states should be available to debug. These include:

Low priority congestion
Local congestion[ 11:0]
Choice [0 . . . 11] next hop congestion [23:0]

Medium priority congestion
Local congestion[ 11:0]
Choice [0 . . . 11] next hop congestion [23:0]

Total above: 26 sets of ˜24b (or less)

The typical debug min/max comparison isn't much good when looking for a particular bit value. Useful feedback would be to count any non-0 state for any one selection of the above. More useful would be able to select a particular bit or set of bits in the bit vector and count if any matching Xoff bit is set (say track if any of 4 ports are congested).

If software has a 5b select (to pick the counter) and a 24b vector to match against, then any time any of the match bits is one for that vector, the count would increase. A 32b count is used with auto-wrap so software does not need to clear the count.

### Local Congestion Feedback

Only fabric ports will give a local congestion response. The management port (for C2 it cannot be a fabric port, but perhaps later it can), host port, or downstream port need never give this feedback. The direction of the fabric port affects how a port reports the congestion, but does not affect the threshold comparison.

Local congestion feedback from portX that says “Xoff” will tell the entire switch to avoid portX for any unordered choice. Each station will look up (associative) portX in the choice to port table to determine which choice(s) target portX.

Software may program 1, 2, or more choices to go to the same portX, which effectively gives portX a weighted choice compared to other choices. Or software may be avoiding a fault and so program two choices to the same port while the fault is active, but have those two choices go to different ports once the fault is fixed.

Hardware will convert the portX local congestion feedback to a local congestion bit vector per priority level, one vector for medium and one vector for low. High priority traffic does not use congestion feedback.

For example, if a local congestion feedback from portX uses choice 1 and 5 and has Xoff set for low priority, then bits[1] and [5] of low_local_congestion would be set. If a later local congestion from portY has Xoff clear for low priority, and portY uses choice 2, then bit[2] of low_local_congest would be cleared.

If *all* legal choices are locally congested, i.e. all 1s, the local congestion filter applied to the legal_choices is set to all 0s since we have to route the packet somewhere.

You may wonder, why not use a count for each choice? Any one station can target any of the 6 stations on a chip. Put another way, there is a fan-in factor of 6 stations to any 1 port in a station. A simple count of traffic sent to one port cannot ever know what other stations sent and so may be off by a factor of 6. Since a count costs a read-modify-write to the RAM and it has dubious accuracy, rather than using a count, hardware will spray the traffic to all possible local ports equally and rely on the local congestion feedback to balance the traffic and avoid hotspots.

There is still a hazard to avoid: namely, avoid having N stations sending to the same port at the same time. Qdepth reflects congestion instantaneously and can be fed back to all ports within the Interstation Bus delay. Qdepth has no memory of what was sent in the past. In the case of a large transient burst targeting one queue, that Qdepth threshold would trigger congestion feedback which should allow that queue time to drain. If the queue does not drain quickly, it will remain Xoff until it finally does drain.

Each source station should have a different choice to port map so that as hardware sequentially goes through the choices, the next port is different for each station. For example, consider x16 ports with 3 stations 0,1,2 feeding into 3 choices that point to ports 12, 16, 20. If port12 is congested, each station will cross the choice that points to port12 off of their legal choices (by setting a choice_congested[priority]). What we want to avoid is having all stations then send to the same next choice, i.e. port 16. If some stations send to port16 and some to port20, then the transient congestion has a chance to be spread out more evenly. The method to do this is purely software programming of the choice to port vectors. Station0 may have choice 1,2,3 be 12, 16, 20 while stationl has choice 1,2,3 be 12, 20, 16, and station 2 has choice 1,2,3 be 20, 12, 16.

A 512 B Cp1D, which is the common remote read completion size and should be a large percent of the unordered traffic, will take 134 ns to sink on an x4, 67 ns on x8, and 34.5 ns on x16. If we can spray the traffic to a minimum of 3× different x4 ports, then as long as we get feedback within 100 ns or so, the feedback will be as accurate as a count from this one station and much more accurate if many other stations targeted that same port in the same time period.

### Next Hop Congestion

For a switch that has no choice of which port to route to, congestion feedback from that one port is helpful if sent to a prior hop back where there was a choice. From the point of view of where the choice is made, this is next hop congestion feedback.

For example, in a Fat Tree the middle switch may have one port congested heading to an edge switch. Next hop congestion feedback will tell the other edge switches to avoid this one center switch for any traffic heading to the one congested port.

A 5-stage Fat Tree, using rank0 on edge, rank1 next, and rank2 in the middle, there is an opportunity for next hop feedback form rank2 to rank1 switch as well as from rank1 to rank0 switch. The rank1 to rank0 feedback gets complicated. Next hop feedback can certainly be applied for any away from center port on the rank1 switch, because there is one port only that is the target for a particular destination. But if there are multiple rankl to rank2 ports that ‘subtractive decode’, the final destination could be reached by using any of them and we have no way to apply the next hop congestion for all cases. What we can do is record the congestion correctly, but we would only be able to use congestion for one of the choices, as we use a NH_LUT[destination] to pick the next hop port for any one choice. Since the rank1 switch is seeing local congestion in this case, it should be trying to balance the traffic to other choices. If there are 3 choices in the rankl switch, then ⅓ of the time the rank0 switch will help the rank1 switch avoid the congestion.

For a non-fat tree, the next hop congestion can help find a better path. The congestion thresholds would have to be set higher, as there is blocking and so congestion will develop. But for the traffic pattern where there is a solution that does not congest, the next hop congestion avoidance ought to help find it. Similar to the 5-stage fat tree, where the rank1 feedback cannot all be used by the rank0 switch, for a 3D torus the next hop feedback only applies for the one port given by the NH-LUT[destination] choice.

Hardware will use the same congestion reporting ring as local feedback, such that the congested ports can send their state to all other ports on the same switch. A center switch could have 24 ports, so feedback for all 24 ports is needed. [The x1 port would not be considered as it should not have significant unordered traffic]

If the egress queue exceeds Toff ns, then an Xoff status will be sent. If the queue drops back to Ton ns or less, then an Xon status will be sent.

Because the feedback must travel across a link, perhaps waiting behind a max length (512 B) packet, the next hop congestion feedback must turn back on before all traffic can drain. An x4 port can send 512+24 in 134 ns. A switch in-to-out latency is around 160 ns. So an Xoff to Xon could take 300 ns to get to the port making a choice to send a packet, which then would take another ˜200 ns to get the TLP to the next hop. Therefore, Xon threshold must be at least 500 ns of queue. Xoff would represent significant congestion, perhaps a queue of 750 ns to 1000 ns.

Next hop congestion feedback applies to more than just 1 hop from the center. For a 5-stage fat tree, it can also be used at the lrst stage to get feedback from the small set of away-from-center choices at the 2^{nd} stage.

Next hop congestion feedback will use a BECN to send information between switches. Every away from center port will send a BECN if the next hop port stays in Xoff state. We don't want to trigger it too often.

### BECN Information

BECN stands for Backwards Early Congestion Notification. It is a concept adapted from Advanced Switching.

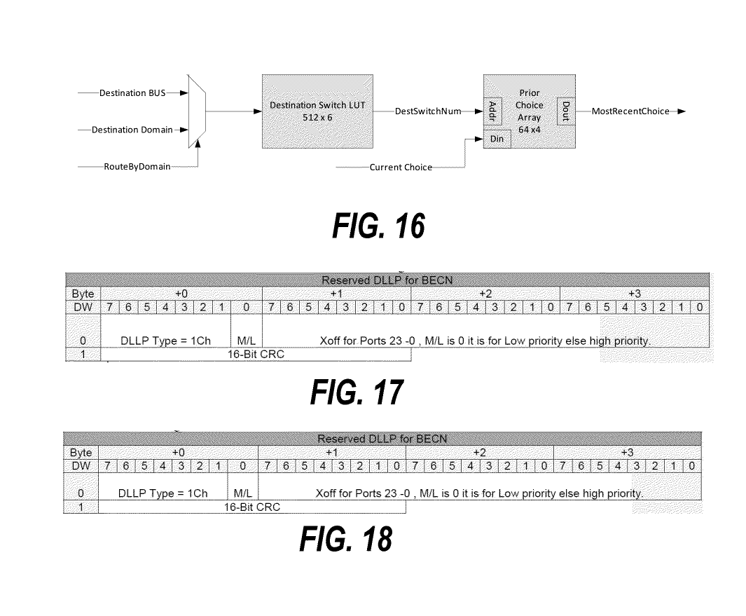

Next hop congestion feedback is communicated using DLLP with Reserved encoding type. Next hop congestion feedback will use a BECN (Backward Early Congestion Feedback Notification) to send information between switches. Every away from center fabric port will send a BECN if the next hop port stays in Xoff state. FIG. 17 is the format of Vendor defined DLLP used for congestion feedback.

The above VDLLP is send if any of the port has Xoff set. This DLLP is treated as high priority DLLP. The two BECN are sent in burst if both low and medium priorities are congested at one time.
When M/L=1 then [23:0] represents for Medium priority.
When M/L=0 then [23:0] represents for Low priority.

The first time any one port threshold triggers Xoff for a chip, BECN will be scheduled immediately for that priority. From that point, subsequent BECN will be scheduled periodically as long as, at least one of the ports remains Xoff. The periodicity of Xoff DLLP is controlled by following programmable register:

TABLE 1
Xoff Update Period Register (Station based Addr: 16′h1040)

| Bit | Attribute | Description | Default |
|---|---|---|---|
| 7:0 | RW | Xoff Update Period for the station. The unit | 8′d50 |
| | | is 2 ns | |
| 31:8 | Rsvd | Reserved | 0 |

The XOff update period should be programmed in such a way that it does not hog the bus and create a deadlock. For example: X1 Gen1 if the update period is 20 ns then DLLP is scheduled every 20 ns and it takes 24 ns to send two dllp for low and medium which will not allow TLP to be scheduled and congestion will not clear up and it will cause deadlock and it will cause deadlock as DLLP will be schedule periodically as long as there is congestion. Whenever the timer counts down to 0, each qualified port in a station will save the active quartile 4b state (up to 4× copies), and then attempt to schedule a burst of BECNs. The Xoff vector for the BECN is simply the corresponding low_and med_BECN state saved in the station. Each active quartile will have one BECN sent until there are no more active quartiles to send. The transmission of BECN is enabled by Congestion management control register.

TABLE 2
Congestion Management Control (1054)

| Bit | Attribute | Description | Default |
|---|---|---|---|
| 3:0 | RW | Enable BECN for port 0-3 where bit 0 | 4′b0 |
| | | represents port0. | |
| 31:4 | Rsvd | Reserved | 0 |

New BECN will be sent as frequently as some programmable spread period “Tspread” per priority (2 value). There is jitter on the receive side of T_spread +J. J can be bound by the time to send a MPS TLP+a few DLLPs. The time between received BECNs would be (T_spread−J)<=time<=(Tspread+J).

For the common case of avoiding a constant ordered flow, there is no hurry to get back to using that congested path. There is little harm in over stalling a congested flow—the link worst case would be out of data for a short time. Long term, throughput will be maintained as, even if all paths are congested, the packet will be sent to one of the non masked choices.
Update a stall time to value XOFF_time with receipt of XOFF
Stall time counts down each clock. If stall time runs out, receiver will tell all ports to turn on the indicated next_hop port
Subsequent received XOFF will reset stall time to XOFF_time
Separate (low+medium+high) and (medium+high) priority counts
A 512 B completion takes 134 ns on x4
Minimum packet is header only ordered MRd TLP with 24 B on the wire takes 6 ns on x4
Use 16 B resolution counter: 2 for header, (payload_length>>2) for payload
24 B header only would count 2
MWr(32)+4 B would count 2 (round down payload)
MWr(32)+16 B would count 2+1=3 (16 B is first to count payload)
16 B counter to nanoseconds depends on link width
Gen3×16 sinks 16 B in 1 ns
Gen3×8 sinks 16 B in 2 ns
Gen3×4 sinks 16 B in 4 ns
Gen2×4 sinks 16 B in 8 ns
Etc

BECN_low_threshold is compared against (low+medium+high) count

BECN_medium_threshold is compared against (medium+high) count

Could medium be XOFF and low not? From thresholds it could be—discuss what to do. Low has some guaranteed bandwidth, so low could make progress if medium is congested.

The BECN information needs to be stored by the receiver. The receiver will update the other ports in its switch via the internal congestion feedback ring.

These are the same bits carried by the feedback ring and the 24×2 flops should hold the information on the Tx side of the link

Like all DLLPs, the Vendor Defined DLLPs are lossy. If a BECN DLLP is lost, then the congestion avoidance indicator will be missed for the time period. As long as congestion persists, BECNs will be periodically sent.

A port that may transmit a BECN is by definition an ‘away from center’ fabric port. BECN only need to be sent if there is at least one port has congestion for either medium or low priority

The first time any one port threshold triggers Xoff for a chip, BECN will be scheduled immediately. From that point, subsequent BECN will be scheduled periodically as long as at least one port remains Xoff. The period should match the time to send a 512 B CpID on the wire, such that a BECN ‘burst’ is sent after each 512 B CpID. A BECN burst can be 1, 2, 3, or 4 BECN DLLPs (costing 8 B to 32 B on the wire). A BECN DLLP is only sent if at least one of the bits in its Xoff vector is set to one.

X16 port can send 532 B in 33.25 ns, x8 in 66.5 ns, and x4 in 133 ns. If each of the 4 BECN can be coalesced (separately), then BECN can be scheduled at the max rate of a burst every 30 ns, and if there is a TLP already in flight, the BECN will wait. X16 will get a BECN burst every 30 ns, while X8 will get a BECN burst every 60 ns, and x4 every 120 ns. The worst case spread of two BECN is therefore (time to send 1 MPS TLP+BECN period).

### BECN Receiver

Any port that receives a DLLP with new BECN information will need to save that information in its own Xoff vector. The BECN receiver is responsible to track changes in Xoff and broadcast the latest Xoff information to other ports on the switch. The congestion feedback ring is used with BECN next hop information riding along with the local congestion.

Since the BECN rides on a DLLP which is lossy, a BECN may not arrive. Or, if the next hop congestion has disappeared, a BECN may not even be sent. The BECN receiver must take care of ‘auto Xon’ to allow for either of these cases.

The most important thing is for a receiver to not turn Xon a next hop if it should stay off. Lost DLLPs are so rare as to not be a concern. However, DLLPs can be stalled behind a TLP and they often are. The BECN receiver must tolerate a Tspread+/−Jitter range, where Tspread is the transmitter BECN rate and Jitter is the delay due to TLPs between BECNs.

Upon receipt of a BECN a counter will be set to Tspread+Jitter. Since the BECN VD-DLLPs should arrive in a burst, a single timer can cover all 4 BECN sets. If the counter gets to 0 before another BECN of any type is received, then all Xoff are cleared. The BECN receiver also sits on the on chip congestion ring. Each time slot it gets on the ring, it will send out information for 12 ports for both medium and low priority queue. The BECN receiver must track which port has had a state change since the last time the on chip congestion ring was updated. The state change could be Xoff to Xon or Xon to Xoff. If there were two state changes or more, that is fine—record it as a state change and report the current value.

### Example of an Implementation

### 1.1.1 Path Selection

More than one path may exist from a source to destination in the fabric. For example in the 3×3 fabric shown in FIG. 10 from a source in left edge switch to the right edge switch, 3 possible paths exist.

Note: the logic describe below exist independently for both medium and low priority.

The 2 stage path information is saved in the local and next hop Destination LUT respectively. The Local DLUT is indexed by destination bus (if the domain of the TLP is current domain) or domain number (if the domain of the TLP is not current domain).

The fault vector or masked choice gives the lists of fabric port where the unordered TLP be routed to. The masked choice is 12 bit vector where each bit when cleared represents valid path for the TLP. The port mapping of each bit in the masked choice vector is located at GEP_MM_STN map starting at offset 1000h.

For example if masked choice vector is 12′hFFC and port of choice 0,1 at offset 1000h is 4,5 respectively then port 4 and 5 are the two possible choices for the current unordered TLP.

Similarly the next hop path for the current TLP is stored in Next Hop Destination LUT which is addressed by the destination bus in the current unordered TLP. If two headers come on single clock, then only TLP on beat 1 will be considered for unordered routing to keep the instance of Next Hop DLUT RAM to 1. If for a particular destination bus all the next hop path is faulty then the software should also remove that fabric port from current hop DLUT for the destination bus.

Each Next Hop DLUT has 8 bit entry for each fabric port (total 96 bits) where MSB 2 bits represent which port to choice vectors table out of 4 the remaining 6 bits maps to. In this way we can selectively cover 24 ports.

Following would be the format of choice vector
[7:6]=0 then [5:0] is the choice vector which maps to choice_to_port vector 0. (6×5=30 flops).
[7:6]=1 then [5:0] is the choice vector which maps to choice_to_port vector 1. (6×5=30 flops).
[7:6]=2 then [5:0] is the choice vector which maps to choice_to_port vector 2. (6×5=30 flops).
[7:6]=3 then [5:0] is the choice vector which maps to choice_to_port vector 3. (6×5=30 flops).

So we need 120 flops for each fabric port for port of choice mapping in NH LUT. The following register implements the Next hop Port to Choice mapping.

TABLE 5
Fabric port 0 port of choice 0 - 0-3 (1060h)

| Bit | Attribute | Description | Default |
|---|---|---|---|
| 4:0 | RW | Port for Choice 0 | 5′d0 |
| 7:5 | Rsvd | Reserved | 0 |
| 12:8 | RW | Port for Choice 1 | 5′d1 |
| 15:13 | Rsvd | Reserved | 0 |
| 20:16 | RW | Port for Choice 2 | 5′d2 |
| 23:21 | Rsvd | Reserved | 0 |
| 28:24 | RW | Port for Choice 3 | 5′d3 |
| 31:29 | Rsvd | Reserved | 0 |

TABLE 6
Fabric Port 0 port of choice 0 - 4-5 (1064h)

| Bit | Attribute | Description | Default |
|---|---|---|---|
| 4:0 | RW | Port for Choice 4 | 5′d4 |
| 7:5 | Rsvd | Reserved | 0 |
| 12:8 | RW | Port for Choice 5 | 5′d5 |
| 31:13 | Rsvd | Reserved | 0 |

TABLE 7
Fabric Port 0 port of choice 1 - 0-3 (1068h)

| Bit | Attribute | Description | Default |
|---|---|---|---|
| 4:0 | RW | Port for Choice 0 | 5′d6 |
| 7:5 | Rsvd | Reserved | 0 |
| 12:8 | RW | Port for Choice 1 | 5′d7 |
| 15:13 | Rsvd | Reserved | 0 |
| 20:16 | RW | Port for Choice 2 | 5′d8 |
| 23:21 | Rsvd | Reserved | 0 |
| 28:24 | RW | Port for Choice 3 | 5′d9 |
| 31:29 | Rsvd | Reserved | 0 |

TABLE 8
Fabric Port 0 port of choice 2 - 4-5 (106Ch)

| Bit | Attribute | Description | Default |
|---|---|---|---|
| 4:0 | RW | Port for Choice 4 | 5′d10 |
| 7:5 | Rsvd | Reserved | 0 |
| 12:8 | RW | Port for Choice 5 | 5′d11 |
| 31:13 | Rsvd | Reserved | 0 |

TABLE 9
Fabric Port 0 port of choice 2 - 0-3 (1070h)

| Bit | Attribute | Description | Default |
|---|---|---|---|
| 4:0 | RW | Port for Choice 0 | 5′d12 |
| 7:5 | Rsvd | Reserved | 0 |
| 12:8 | RW | Port for Choice 1 | 5′d13 |
| 15:13 | Rsvd | Reserved | 0 |
| 20:16 | RW | Port for Choice 2 | 5′d14 |
| 23:21 | Rsvd | Reserved | 0 |
| 28:24 | RW | Port for Choice 3 | 5′d15 |
| 31:29 | Rsvd | Reserved | 0 |

TABLE 10
Fabric Port 0 port of choice 2- 4-5 (1074h)

| Bit | Attribute | Description | Default |
|---|---|---|---|
| 4:0 | RW | Port for Choice 4 | 5′d16 |
| 7:5 | Rsvd | Reserved | 0 |
| 12:8 | RW | Port for Choice 5 | 5′d17 |
| 31:13 | Rsvd | Reserved | 0 |

TABLE 11
Fabric Port 0 port of choice 3 - 0-3 (1078h)

| Bit | Attribute | Description | Default |
|---|---|---|---|
| 4:0 | RW | Port for Choice 0 | 5′d18 |
| 7:5 | Rsvd | Reserved | 0 |
| 12:8 | RW | Port for Choice 1 | 5′d19 |
| 15:13 | Rsvd | Reserved | 0 |
| 20:16 | RW | Port for Choice 2 | 5′d20 |
| 23:21 | Rsvd | Reserved | 0 |
| 28:24 | RW | Port for Choice 3 | 5′d21 |
| 31:29 | Rsvd | Reserved | 0 |

TABLE 12
Fabric Port 0 port of choice 3 - 4-5 (107Ch)

| Bit | Attribute | Description | Default |
|---|---|---|---|
| 4:0 | RW | Port for Choice 4 | 5′d22 |
| 7:5 | Rsvd | Reserved | 0 |
| 12:8 | RW | Port for Choice 5 | 5′d23 |
| 31:13 | Rsvd | Reserved | 0 |

The Port of Choice for Fabric Ports 1-11 Exist in the Address Range 1080h-10DCh in Sequence.

### EXAMPLE

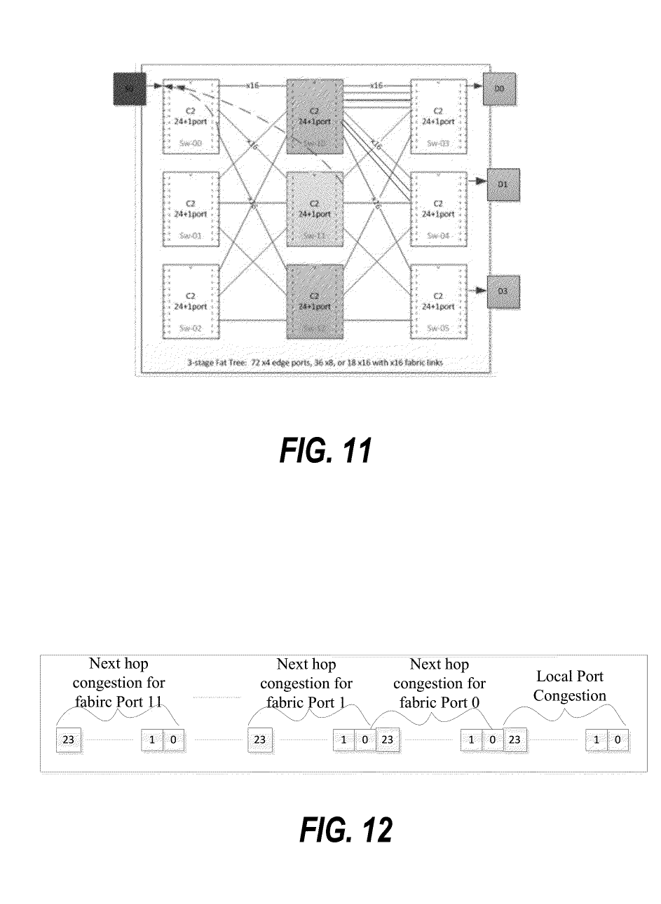

The following example, illustrated in FIG. 11 describes the next hop LUT programming and implementation logic for the 3×3 fabric illustrated in FIG. 10.

The Source is S0 1104 and the three destinations D0,D1,D2 1108, 1112, 1116.
There exist four paths from switch SW10 1120 to SW 03 1124 which leads to D0 1108. In this example, they are port number 0,4,5,6 on SW10 1120.
There exist three paths from switch SW10 1120 to SW 04 1128 which leads to D1 1112. In this example, they are port numbers 8,12,13 on switch SW10 1120.
Lastly, there exists one path from switch SW10 1120 to SW 05 1132 which leads to D2 1116. In this example, the port number for the path is 16 on switch SW10 1120.

Now when software programs the NHLUT (Next hop look up table) for D0 1108 (destination bus D0) index the 8 bit entry would be

[7:0] - 00_110000
Note: 0 indicates the choice is valid.
And Port of Choice for fabric port 0 Choice 0 (register 1060-1064h)
would be

| | | | | | |
|---|---|---|---|---|---|
| Don't care | Port 16 | Port 6 | Port 5 | Port 4 | Port 0 |

So when the choice to port is converted it will indicate all the four ports exist for destination port 0.

Similarly for D1 1112 the choice vector would be

[7:0] - 01_111000
And Port of Choice for fabric port 0 Choice 1 (register 1068-106Ch)
would be

| | | | | | |
|---|---|---|---|---|---|
| Don't care | Don't Care | Don't Care | Port 13 | Port 12 | Port 8 |

For D3 1116 the vector can be [7:0]—00_101111
This will refer to And Port of Choice for fabric port 0 Choice 0(register 1060-1064h), which has port 16 on the 4th entry.

The arbiter chooses each path in round robin fashion to balance the traffic. Sometimes, some of the path might be congested (has higher latency) because it might be the path for some ordered traffic. Hence, a good choice would be to send the TLP on the path which is not congested. The arbiter along with last path selected makes decision on the congestion information. Each station keeps track of the congestion of all the fabric ports in the switch along with the next hop port congestion information.

The congestion information within the chip is communicated using a congestion feedback ring which is described in the next section. For the center switch we can have all the 24 ports as a fabric port. To save the congestion information we will need 312 bits+24 (local congestion information)+12*24 (next hop congestion information)=312 bits.

The congestion information is saved in each station in the following format 0, as shown in FIG. 12.

The next hop congestion information is communicated using Vendor Defined DLLP which is described in coming section. FIG. 13 illustrates the logic for selecting a particular egress port for the unordered TLP:

The final congestion vector derived by following logic:
If (all the choices are congested) then

If (all local is congested and all next hop is congested)
List of all choices available is the final vector (masked choice)

Else
The choice which is not congested at both levels is in the list of choices.
Else

The choice which is not congested at both the level is considered.

The local domain bus is mapped from 256-511 in the next hop DLUT and remote domain is mapped from 0-255.

### Congestion Feedback Ring

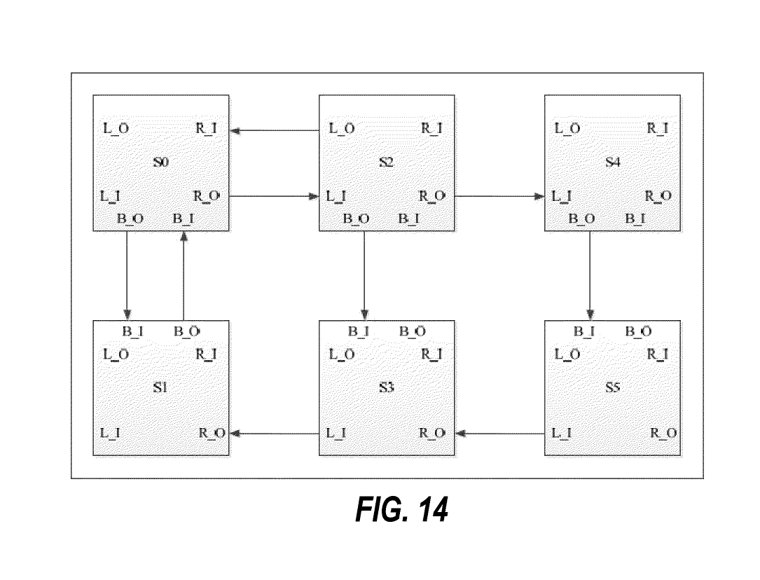

The congestion information between the stations is exchanged on the congestion ring, as shown in FIG. 14, where each fabric port puts its information on the bus at its slot, which is programmed by management CPU.

Each port reports its congestion information along with the next hop congestion information of the switch it is connected to. If there is no change in Xoff information from the last time a station updated its information on the bus, then it puts the same data as last one on its slot. The congestion information is named as Xoff which represents congestion when it is set. The congestion information is different for low and medium priority packets. The next hop congestion information is reported by DLLP with encoding type as ReservedVendor Defined DLLP. Following table specifies the fields used on the congestion bus:

TABLE 13
Local Congestion Bus Details

| Bit | Description |
|---|---|
| 0 | Local port low priority Xoff. |
| 1 | Local port medium priority Xoff. |
| 6:2 | Local Port number. |
| 18:7 | Next hop low priority Xoff. |
| 30:19 | Next hop medium priority Xoff. |
| 31 | Low priority next hop low/high port. When 0, field [18:7] |
| | represents for next hop port number from 0 to 11. When 1, |
| | field [18:7] represents for next hop port number from 12 to 23. |
| 32 | Valid. Information on the bus is valid when this bit is set. |

Each station gets a slot numbers per update cycle which is programmed by software using following register:

TABLE 14
Congestion feedback Ring Slot Register
(Station Based) (Offset 20′h1050)

| Bit | Attribute | Description | Default |
|---|---|---|---|
| 4:0 | RW | Slot 0 for the station | Station_id *4 + 1 |
| 5 | RW | Valid - Slot is valid | 1′b1 |
| 7:6 | Rsvd | Reserved | 3′h0 |
| 12:8 | RW | Slot 1 for the station | Station_id *4 + 2 |
| 13 | RW | Valid - Slot is valid | 1′b1 |
| 15:14 | Rsvd | Reserved | 3′h0 |
| 21:16 | RW | Slot 2 for the station | Station_id *4 + 3 |
| 22 | RW | Valid - Slot is valid | 1′bl |
| 24:23 | Rsvd | Reserved | 3′h0 |
| 28:24 | RW | Slot 3 for the station | Station_id *4 + 4 |
| 20 | RW | Valid - Slot is valid | 1′b1 |
| 31:30 | Rsvd | Reserved | 3′h0 |

TABLE 15
Max Congestion Ring Slot (Chip Based: Offset 20′hF005C)

| Bit | Attribute | Description | Default |
|---|---|---|---|
| 0 | RW | Next Hop Congestion Enable: This will | 0 |
| | | enable next hop congestion and next hop | |
| | | masked choice to account for on deciding | |
| | | the port number. It the bit is clear only the | |
| | | current hop information is looked at. | |
| 5:1 | RW | Maximum number of slots excluding the | No of |
| | | start pulse. | Station * 4 |
| 6 | RW | Current HOP Congestion Enable: This | 1′b0 |
| | | will enable current hop congestion | |
| | | information to decide the port number. By | |
| | | default only Current HOP fault vector is | |
| | | looked at. | |
| 31:6 | Rsvd | Reserved | 0 |

To meet the timing, number of pipeline stages might be added, which adds additional latency into the bus. The update on the congestion ring starts with a start pulse where Station 0 puts the Local port number as 5′b11111 and valid field (bit 33) as 1. The slot 0 is reserved for start pulse out of total number of slots and it should not be assigned to any of the station OR the slot assignment starts from slot 1. After the start pulse, the station which is assigned slotl puts the congestion information followed by slot 2 and so on. The station 0 sends the start pulse again once the maximum number of slots is already on the bus. Each station maintains a local counter which gets synchronized by the arrival of start pulse.

### Congestion Threshold Counter

Each port maintains a counter to keep track of the number of DW is on the egress queue. This count eventually decides the latency for a “new packet scheduled” to be put on wire which depends upon the physical bandwidth of the port. The counter has 4 DW (4 double word or 16 bytes) granularity, which gets incremented when the scheduler puts the TLP on the queues. The counter is decremented by the number of DW scheduled by scheduler. The counter is implemented separately for each low and high priority queue. This counter is used to decide the congestion status of a port. The management software is responsible for programming the Xmax/Xmin threshold. The port is congested or Xoffed if the count crosses the Xmax threshold and not congested or Xoned if the count is below the Xmin threshold. This counter is maintained individually for each medium and low priority queue. The low priority counter is incremented if any low+medium+high priority TLP is scheduled and same for decrement. For every Header the counter is inc/dec by 2 instead of 1 as it accounts for overhead associated with every TLP. It the payload is less than 1 then counter will not be incremented or decremented. The medium priority counter is incremented if any medium+high priority TLP is scheduled. The station based threshold register is shown below.

TABLE 16
Xoff Threshold Register 0 for Low Priority (Offset 16′h1020)

| Bit | Attribute | Description | Default |
|---|---|---|---|
| 15:0 | RW | Xoff threshold for all ports in a station. | 12′d300 |
| | | Each count is 1 ns. | |
| 31:16 | RW | Xon threshold for all Ports in a station. The | 12′d200 |
| | | unit is 1 ns. | |

TABLE 17
Xoff Threshold Register 0 for Medium Priority (Offset 16′h1030)

| Bit | Attribute | Description | Default |
|---|---|---|---|
| 15:0 | RW | Xoff threshold for all ports in a station. | 12′d300 |
| | | Each count is 1 ns. | |
| 31:16 | RW | Xon threshold for all Ports in a station. The | 12′d200 |
| | | unit is 1 ns. | |

Since the feedback must travel across a link, perhaps waiting behind a max length (512 B) packet, the next hop congestion feedback must turn back on before all traffic can drain. An x4 port can send 512+24 in 134 ns. A switch in-to-out latency is around 160 ns. So an Xoff to Xon could take 300 ns to get to the port making a choice to send a packet, the next hop congestion feedback must turn back on before all traffic can drain.
For x16 Gen3−160+134/4=160+34=194 ns
For x8 Gen3−160+134/2=160 +67=227 ns
For x4 Gen3−160+134=300 ns
   To choose the default value of Xoff, the counter should have value of 512 Bytes+24 Bytes+840 (160 ns for X16 Gen3)=1376 bytes/16=86 (4 DWs)

### Next Hop Congestion Feedback

### Transmitter

Next hop congestion feedback is communicated using BECN which is PCIe DLLP with encoding type as Reserved Next hop congestion feedback will use a BECN (Backward Early Congestion Feedback Notification) to send information between switches. Every away from center fabric port will send a BECN if the next hop port stays in Xoff state. FIG. 18 is the format of Vendor defined DLLP used for congestion feedback.

The above VDLLP is send if any of the port has Xoff set. This DLLP is treated as high priority DLLP. The two BECN are sent in burst if both low and medium priorities are congested at one time.
When M/L=1 then [23:0] represents for Medium priority.
When M/L=0 then [23:0] represents for Low priority.

The first time any one port threshold triggers Xoff for a chip, BECN will be scheduled immediately for that priority. From that point, subsequent BECN will be scheduled periodically as long as, at least one of the ports remains Xoff. The periodicity of Xoff DLLP is controlled by following programmable register:

TABLE 18
Xoff Update Period Register (Station based Addr: 16′h1040)

| Bit | Attribute | Description | Default |
|---|---|---|---|
| 7:0 | RW | Xoff Update Period for the station. The unit | 8′d50 |
| | | is 2 ns | |
| 31:8 | Rsvd | Reserved | 0 |

The XOff update period should be programmed in such a way that it does not hog the bus and create a deadlock. For example: X1 Gen1 if the update period is 20 ns then DLLP is scheduled every 20 ns and it takes 24 ns to send two dllp for low and medium which will not allow TLP to be scheduled and congestion will not clear up and it will cause deadlock and it will cause deadlock as DLLP will be schedule periodically as long as there is congestion. Whenever the timer counts down to 0, each qualified port in a station will save the active quartile 4b state (up to 4× copies), and then attempt to schedule a burst of BECNs. The Xoff vector for the BECN is simply the corresponding low_and med_BECN state saved in the station. Each active quartile will have one BECN sent until there are no more active quartiles to send. The transmission of BECN is enabled by Congestion management control register.

TABLE 19
Congestion Management Control (1054)

| Bit | Attribute | Description | Default |
|---|---|---|---|
| 3:0 | RW | Enable BECN for port 0-3 where bit 0 | 4′b0 |
| | | represents port0. | |
| 31:4 | Rsvd | Reserved | 0 |

### Receiver

Any port that receives a DLLP with new BECN information will need to save that information in its own Xoff vector. The BECN receiver is responsible to track changes in Xoff and broadcast the latest Xoff information to other ports on the switch. Each fabric port maintains a 24 bit next hop congestion vector. The congestion feedback ring is used with BECN next hop information riding along with the local congestion. The port only publishes the Xoff information on the congestion feedback ring which has changed from its last time slot.

The Xoff is not send by the transmitter if the congestion is disappeared. Sometime the DLLP might be even lost because of the lossy medium. Hence auto Xon feature is implemented in the receiver. The receiver maintains a timer and a counter to implement this auto Xon feature. The timer, which is programmable and is one per fabric port, keeps track when the next Xoff DLLP should arrive. The 2 bit counter is maintained one per next hop port. It is incremented when the corresponding Xoff bit is set on the incoming BECN. The counter is decremented when the previously described timer expires. When the count reaches 0 the port state is changed to Xon.

TABLE 20
Xoff Rx Timer Register (Offset 16′h1050)

| Bit | Attribute | Description | Default |
|---|---|---|---|
| 7:0 | RW | Xoff Receive Period for the station | 8′d50 |
| 31:8 | Rsvd | Reserved | 0 |

### Congestion Information Management Block Diagram

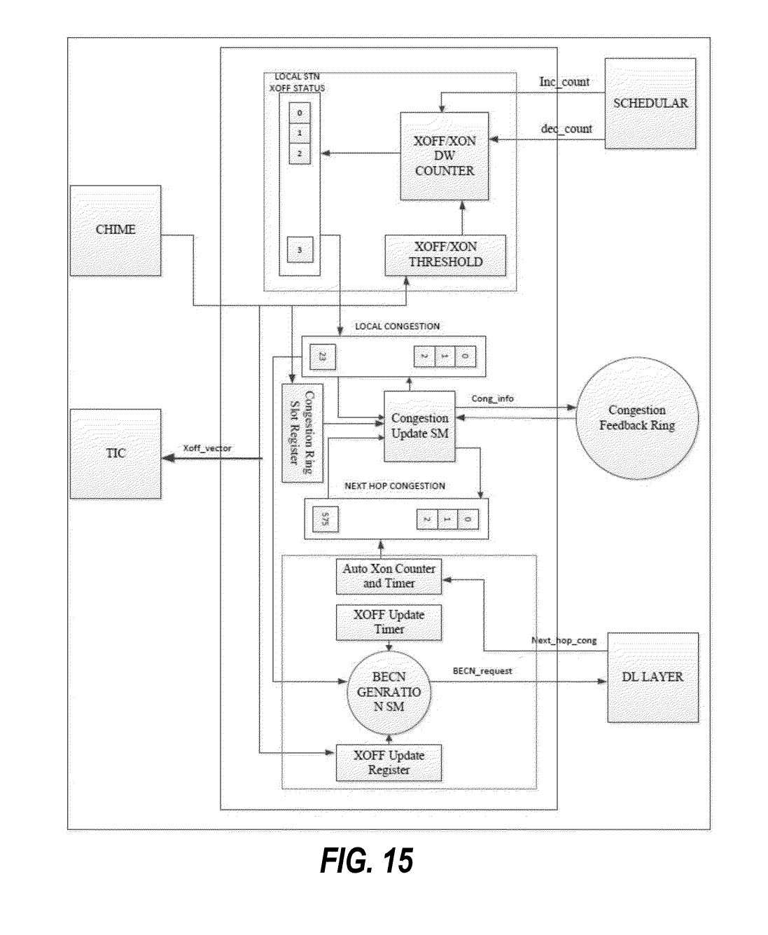

FIG. 15 is a schematic illustration of a congestion information management block. The congestion information management block is responsible for collecting local and next hop congestion information which is used by TIC for choosing appropriate path for unordered TLP. The whole logic is divided into three blocks:

### Local Xoff Detection

It maintains a counter to keep track of number to DW into the egress queue of port which eventually gives the latency for the new tlp scheduled. The counter has granularity of 4 DW and is incremented whenever scheduler put the TLP into the queue and decremented when schedules the TLP to passes the information to Reader. The count is compared with the Xoff/Xon threshold register and Xoff status is updated for the local ports.

### Congestion Feedback Ring Logic

The congestion feedback ring illustrated in FIG. 14 takes the congestion bus from the previous station and passes it to the next station to complete the ring as shown in the above diagram. For Six stations the bus flows from S0-S2-S4-S5-S3-S1. It also inserts the local station congestion information into the ring on its time slot decided by Congestion Feedback Ring Slot Register. The maximum number of slots provided per station is 4. All the other station congestion information is used to update the final Xoff vector.

### Next Hop Congestion Transmit and Receive Logic

### Transmit Logic

Whenever there is change in local Xoff vector (all 24 ports) then the logic request DL layer to transmit BECN (VDLLP) with new Xoff vector. The first time any one port Xoff is set, BECN will be scheduled immediately. From that point, subsequent BECN will be scheduled periodically as long as at least one of the ports remains Xoff. The periodicity of Xoff DLLP is controlled XOFF Update Register CSR.

### Receive Logic

The next hop congestion information is communicated by DL layer separately for each port. The receiver maintains a timer and a counter to implement this auto Xon feature. The timer, which is programmable and is one per fabric port, keeps track when the next Xoff DLLP should arrive. The 2 bit counter is maintained one per next hop port. It is incremented when the corresponding Xoff bit is set on the incoming BECN. The counter is decremented when the previously described timer expires. When the count reaches 0 the port state is changed to Xon.

Finally the Xoff congestion information is communicated to TIC which has the format, as shown in FIG. 12:

Glossary of Terms

| | |
|---|---|
| API | Application Programming Interface |
| BDF | Bus-Device-Function (8 bit bus number, 5 bit device number, 3 bit function |
| | number of a PCI express end point/port in a hierarchy). This is usually |
| | set/assigned on power on by the management CPU/BIOS/OS that enumerates the |
| | hierarchy. In ARI, “D” and “F” are merged to create an 8-bit function number |
| BCM | Byte Count Modified bit in a PCIe completion header. In ExpressFabric ™, BCM |
| | is set only in completions to pull protocol remote read requests |
| BECN | Backwards Explicit Congestion Notification |
| BIOS | Basic Input Output System software that does low level configuration of PCIe |
| | hardware |
| BUS | the bus number of a PCIe or Global ID |
| CSR | Configuration Space Registers |
| CAM | Content Addressable Memory (for fast lookups/indexing of data in hardware) |
| CSR Space | Used (incorrectly) to refer to Configuration Space or an access to configuration |
| | space registers using Configuration Space transfers; |
| DLUT | Destination Lookup Table |
| DLLP | Data Link Layer Packet |
| Domain | A single hierarchy of a set of PCI express switches and end points in that |
| | hierarchy that are enumerated by a single management entity, with unique BDF |
| | numbers |
| Domain | PCI express address space shared by the PCI express end points and NT ports |
| address | within a single domain |
| space | |
| DW | Double word, 32-bit word |
| EEPROM | Electrically erasable and programmable read only memory typically used to store |
| | initial values for device (switch) registers |
| EP | PCI express end point |
| FLR | Function Level Reset for a PCI express end point |
| FUN | A PCIe “function” identified by a Global ID, the lowest 8 bits of which are the |
| | function number or FUN |
| GEP | Global (management) Endpoint of an ExpressFabric ™ switch |
| GID | Global ID of an end point in the advanced Capella 2 PCI ExpressFabric ™. GID = |
| | {Domain, BUS, FUN} |
| Global | Address space common to (or encompassing) all the domains in a multi-domain |
| address | PCI ExpressFabric ™. If the fabric consists of only one domain, then Global and |
| space | Domain address spaces are the same. |
| GRID | Global Requester ID, GID less the Domain ID |
| H2H | Host to Host communication through a PLX PCI ExpressFabric ™ |
| LUT | Lookup Table |
| MCG | A multicast group as defined in the PCIe specification per the Multicast ECN |
| MCPU | Management CPU - the system/embedded CPU that controls/manages the |
| | upstream of a PLX PCI express switch |
| MF | Multi-function PCI express end point |
| MMIO | Memory Mapped I/O, usually programmed input/output transfers by a host CPU |
| | in memory space |
| MPI | Message Passing Interface |
| MR | Multi-Root, as in MR-IOV, as used herein multi-root means multi-host. |
| NT | PLX Non-transparent port of a PLX PCI express switch |
| NTB | PLX Non-transparent bridge |
| OS | Operating System |
| PATH | PATH is a field in DMA descriptors and VDM message headers used to provide |
| | software overrides to the DLUT route look up at enabled fabric stages. |
| PIO | Programmed Input Output |
| P2P, PtoP | Abbreviation for the virtual PCI to PCI bridge representing a PCIe switch port |
| PF | SR-IOV privileged/physical function (function 0 of an SR-IOV adapter) |
| RAM | Random Access Memory |
| RID | Requester ID - the BDF/BF of the requester of a PCI express transaction |
| RO | Abbreviation for Read Only |
| RSS | Receive Side Scaling |
| Rx CQ | Receive Completion Queue |
| SEC | The SECondary BUS of a virtual PCI-PCI bridge or its secondary bus number |
| SEQ | abbreviation for SEQuence number |
| SG list | Scatter/gather list |
| SPP | Short Packet Push |
| SR-PCIM | Single Root PCI Configuration Manager - responsible for configuration and |
| | management of SR-IOV Virtual functions; typically an OS module/software |
| | component built in to an Operating System. |
| SUB | The subordinate bus number of a virtual PCI to PCI bridge. |
| SW | abbreviation for software |
| TC | Traffic Class, a field in PCIe packet headers. Capella 2 host-to-host software |
| | maps the Ethernet priority to a PCIe TC in a one to 1 or many to 1 mapping |
| T-CAM | Ternary CAM, a CAM in which entry includes a mask |
| TSO | TCP Segmentation offload |
| Tx CQ | Transmit Completion Queue |
| TxQ | Transmit queue, e.g. a transmit descriptor ring |
| TWC | Tunneled Window Connection endpoint that replaces non-transparent bridging to |
| | support host to host PIO operations on an ID-routed fabric |
| TLUT | Tunnel LUT of a TWC endpoint |
| VDM | Vendor Defined Message |
| VEB | Virtual Ethernet Bridge (some backgrounder on one implementation: |
| | http://www.ieee802.Org/1/files/public/docs2008/new-dcb-ko-VEB-0708.pdf) |
| VF | SR-IOV virtual function |
| VH | Virtual Hierarchy (the path that contains the connected host's root complex and |
| | the PLX PCI express end point/switch in question) |
| WR | Work Request as in the WR VDMs used in host to host DMA |

### Extension to Other Protocols

While a specific example of a PCIe fabric has been discussed in detail, more generally, the present invention may be extended to apply to any switch that includes multiple paths some of which may suffer congestion. Thus, the present invention has potential application for other switch fabrics beyond those using PCIe.

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

What is claimed is:

1. A method of providing unordered path routing in a multi-path PCIe switch fabric, the method comprising:
measuring port congestion on a local level
receiving port congestion information of a next hop level, wherein the congestion information comprises low priority congestion information and medium priority congestion information;
using a congestion feedback interconnect, such as a ring or bus, to communicate congestion within a chip, wherein only fabric ports send congestion information of the local level and an applicable next hop level to the congestion feedback ring;
communicating local congestion information on said interconnect for both low priority congestion information and medium priority congestion information to a previous hop using a data link layer packet (DLLP) with a Reserved encoding;
providing a masked choice vector that lists the number of paths available on the switch to route an unordered packet to a particular destination;
saving the masked choice vector in a current hop destination look up table (CH-DLUT);
providing a next hop masked choice vector that lists a number of choices available on the next hop per a local fabric port to route an unordered packet to a particular destination;
saving the next hop masked choice vectors in a next hop destination look up table (NH-DLUT); and
using the next hop masked choice vectors for a particular destination with a set of Port of Choice tables to construct a next hop masked port vector for that destination
using the masked choice vector stored in the CH-DLUT and next hop masked port vector constructed from NH-DLUT and Ports of Choices tables respectively at locations corresponding to an unordered packets destination and their corresponding congestion information to determine a switching path for then unordered packet.

2. A method as recited in claim 1, wherein the masked choice vector lists a plurality of fabric ports of the switch.

3. The method, as recited in claim 2, further comprising communicating next hop congestion information using a data link layer packet (DLLP) with a Reserved or a Vendor Defined encoding.

4. The method, as recited in claim 3, wherein each local egress port maintains a counter, which counts the number of double words on an egress queue for the port, and wherein the number of double words is used to determine congestion for the port.

5. The method, as recited in claim 4, further comprising using programmable thresholds for the counters to determine congestion.

6. A method of providing unordered path routing in a multi-path PCIe switch fabric, the method comprising:
measuring port congestion on a local level;
receiving port congestion information of a next hop level;
providing a masked choice vector that lists a number of paths available on the switch to route an unordered packet to a particular destination;
saving the masked choice vector in a current hop destination look up table (CH-DLUT);
providing a next hop masked choice vector that lists a number of paths available on the next hop per a local fabric port to route an unordered packet to a particular destination;
saving the next hop masked choice vector in a next hop destination look up table (NH-DLUT); and
using the masked choice and next hop masked choice vector stored in the CH-DLUT and NH-DLUT and their corresponding congestion information to determine a switching path for an unordered packet.

7. A method as recited in claim 6, wherein the masked choice vector lists a plurality) of fabric ports.

8. The method, as recited in claim 7, further comprising using a congestion feedback interconnect such as a ring or bus to communicate congestion within a chip.

9. The method, as recited in claim 8, wherein only fabric ports send congestion information of the local level and an applicable next hop level to the congestion feedback ring.

10. The method, as recited in claim 9, further comprising communicating next hop congestion information using a data link layer packet (DLLP) with a Reserved or Vendor Defined encoding.

11. The method, as recited in claim 10, wherein each fabric port provides to the congestion feedback ring the ports congestion information and next hop congestion information.

12. The method, as recited in claim 11, wherein the congestion information comprises low priority congestion information and medium priority congestion information.

13. The method, as recited in claim 12, wherein each port maintains a counter, which counts the number of double words stored in the egress queues for the port, and wherein the number of double words contained in the queues is used to determine congestion for the port.

14. The method, as recited in claim 13, further comprising using programmable thresholds for the counters to determine congestion.

15. The method, as recited in claim 14, further comprising periodically (with a configurable period) sending a reserved DLLP between switches from a center fabric port while a next hop port stays congested.

16. A method as recited in claim 15, further comprising:
masking off route choices in a destination look up table according to route congestion or route fault;
broadcasting congestion feedback over a local switch ring;
using an auto-XON feature; and

[symbol]

17. A system comprising:
a switch fabric including at least two PCIe ExpressFabric™ switches and a management system, wherein the switch fabric comprises at least a plurality of switches, wherein each switch comprises:
a plurality of ports, wherein some of the plurality of ports are fabric ports; and
a feedback congestion ring which collects a congestion information only from fabric ports, wherein the congestion information provides port congestion on a local level and port congestion on an applicable next hop level;
an ingress scheduler, which collects congestion information from fabric ports on the same switch and congestion from the fabric ports on the next hop switch, wherein the uncongested paths derived form masked vector and the congestion information is used to select a single route for unordered packets, using a round robin process if multiple route choices or no route choices remain unmasked after local next hop congestion feedback masks have been applied.

18. The system, as recited in claim 17, wherein each port of the plurality of ports maintains a counter, whose value is proportional to the depth of the egress queue for the port, and wherein the value of the counter is used to determine congestion for the port.

19. The system, as recited in claim 18, further comprising programmable thresholds for the counters to determine congestion.
